(19) United States
(12) Patent Application Publication
(10) Pub. No.: US 2012/0268073 A1
(43) Pub. Date: Oct. 25, 2012

(54) NONAQUEOUS ELECTROLYTE BATTERY, ROLLED ELECTRODE ASSEMBLY COLLECTOR, LAYER-BUILT ELECTRODE ASSEMBLY COLLECTOR, AND METHOD FOR MANUFACTURING NONAQUEOUS ELECTROLYTE BATTERY COLLECTOR

(75) Inventors: Tokuhiro Morioka, Miyagi (JP); Hitoshi Watanabe, Miyagi (JP); Kaoru Abe, Fukushima (JP); Akihisa Sakamoto, Fukushima (JP); Takakazu Hirose, Fukushima (JP); Kenichi Kawase, Fukushima (JP)

(73) Assignee: SONY CORPORATION, Tokyo (JP)

(21) Appl. No.: 13/440,588

(22) Filed: Apr. 5, 2012

(30) Foreign Application Priority Data
Apr. 21, 2011 (JP) 2011-095488

(51) Int. Cl. H02J 7/00; B21D 33/00; H01M 10/05; H01M 4/64; H01M 2/02

(52) U.S. Cl. 320/128; 429/211; 429/156; 29/17.2

(57) ABSTRACT

A nonaqueous electrolyte battery provided with a rolled electrode assembly, in which a positive electrode including a positive electrode active material layer disposed on a positive electrode collector formed from metal foil and a negative electrode including a negative electrode active material layer disposed on a negative electrode collector formed from metal foil are stacked with a separator therebetween and are rolled, and an electrolyte, wherein at least one of the positive electrode collector and the negative electrode collector has a compressed pattern portion which is disposed as a part of the metal foil and which has a thickness smaller than that of the other portion through compression, and the compressed pattern portion from one end parallel to the rolling direction of the metal foil to the other end opposite to the one end is not disposed continuously in the direction orthogonal to the rolling direction of the metal foil.

### CROSS REFERENCES TO RELATED APPLICATIONS

The present application claims priority to Japanese Priority Patent Application JP 2011-095488 filed in the Japan Patent Office on Apr. 21, 2011, the entire content of which is hereby incorporated by reference.

### BACKGROUND

The present disclosure relates to a nonaqueous electrolyte battery, a rolled electrode assembly collector, a layer-built electrode assembly collector, and a method for manufacturing a nonaqueous electrolyte battery collector. In particular, the present disclosure relates to a nonaqueous electrolyte battery in which damages, e.g., breakage, in an electrode collector may be suppressed, a rolled electrode assembly collector, a layer-built electrode assembly collector, and a method for manufacturing a nonaqueous electrolyte battery collector.

In recent years, along with the spread of portable information electronic apparatuses, e.g., cellular phones, video cameras, and notebook-size personal computers, enhancement of performance, miniaturization, and weight reduction of these apparatuses have been intended. As for the power supplies of these apparatuses, disposable primary batteries and reusable secondary batteries have been used. In this regard, demands for the secondary batteries, in particular lithium ion secondary batteries, have increased from the viewpoint of good overall balance between enhancement of performance, miniaturization, weight reduction, economical efficiency, and the like. Regarding these apparatuses, further enhancement of performance, miniaturization, and the like have been underway. Regarding the lithium ion secondary battery as well, a still higher energy density is desired. The lithium ion secondary batteries have high energy densities and, therefore, are also used us batteries mounted on electric tools, electrically-assisted bicycles, electric cars, hybrid cars, and the like.

Positive electrodes and negative electrodes constituting these batteries are formed by disposing an active material layer containing a positive electrode active material or a negative electrode active material on the surface of a metal foil collector typified by, for example, aluminum foil, copper foil, or the like. These collectors undergo various mechanical loads during production of the battery, for example, formation of an active material layer and rolling, and during use of the batteries, in which charge and discharge are performed. Consequently, in the case where the load applied to the collector is too large, the collector may be cut or broken. According to this, a low yield problem in production of the battery and a defective product problem of the produced battery may occur.

It is believed that the above-described defects of the product occur mainly due to expansion and shrinkage along with charge and discharge of the active material layer disposed on the collector during use of the battery. For example, as for the negative electrodes, carbon materials and metal materials, e.g., metal alloys, are used as the negative electrode active materials. In the case where silicon (Si), among them, is used as the negative electrode active material, the change in volume along with expansion and shrinkage of the negative electrode active material layer during charge and discharge is quadrupled. Consequently, a tensile stress and a compressive stress are applied to the negative electrode collector along with expansion and shrinkage of the negative electrode active material layer, and the negative electrode collector undergoes plastic deformation and is broken finally. Such a problem is not limited to the negative electrode collector, but is a problem which may occur with respect to the positive electrode collector constituting the positive electrode stacked on the negative electrode with a separator therebetween while being in press contact with the negative electrode.

In order to solve the above-described problems, for example, it has been proposed to increase the resistance to a mechanical load applied to the collector. As for such a method, for example, it has been proposed to use rolled metal foil, which has a yield strength improved by rolling the metal foil, as the collector.

However, in general, the rolled metal foil has high brittleness as compared with that of the metal foil before rolling. The yield strength and the elongation of the metal foil is in the relationship of trade-off. That is, as the yield strength of the metal foil increases, the elongation is reduced, and as the elongation increases, the yield strength is reduced. Consequently, the rolled metal foil is broken easily by a small strain or a minute defect. For example, in formation of an active material layer on the collector surface (application of a mix, pressing of an active material layer, cutting of electrode, and the like) performed through so-called roll to roll or rolling of the electrode, the collector formed from the rolled metal foil is broken easily and the yield is reduced easily.

Meanwhile, in the case where the rolled metal foil is used, even if the battery can be produced without an occurrence of production problem in each of the above-described battery production processes, there is no change in the situation that the brittleness of the collector in itself is high and the collector is broken easily. Consequently, under the present circumstances, a satisfactory solution has not been obtained with respect to the above-described problems.

In general, the price of the rolled metal foil tends to become higher than the price of metal foil not subjected to the rolling treatment, and a problem occurs in that an increase in battery cost is brought about.

As for another solution to the above-described problems, it is considered that the thickness of metal foil used as the collector is increased. Regarding a collector by using metal foil thicker than the collector used for a battery in related art, the above-described collector breakage problem does not occur easily during production of the battery or during use of the battery. However, the proportion of the collector not contributing to a battery reaction relative to the battery capacity increases and, thereby, the capacity of the whole battery is reduced.

Then, Japanese Unexamined Patent Application Publication No. 2005-32524 proposes a configuration of copper foil for a lithium ion battery, wherein a plurality of pore portions in the shape of a rhombus or the like having in-plane anisotropy are disposed. According to the configuration of Japanese Unexamined Patent Application Publication No. 2005-32524, changes in the dimension of a negative electrode material in expansion and shrinkage along with movement of ions may be anisotropically absorbed by the copper foil provided with pore portions in the shape of a rhombus or the like. Consequently, an occurrence of cracking in the negative electrode material may be prevented.

Furthermore, Japanese Unexamined Patent Application Publication No. 7-192726 proposes a configuration in which a plurality of discontinuous notches are provided in a metal foil collector. According to the configuration of Japanese Unexamined Patent Application Publication No. 7-192726, notches are disposed in the collector and, thereby, in formation of an active material layer and the like, the metal foil collector follows smoothly the elongation of the active material layer in the transverse direction relative to the direction of the pressure, where the elongation occurs when the active material layer is subjected to press-forming. Consequently, the electrode after press-forming of the active material layer has a low level of strain and is not twisted, so that a flat electrode may be obtained.

### SUMMARY

It is believed that the pore portions disposed in the collector in Japanese Unexamined Patent Application Publication No. 2005-32524 described above are through holes because of the effect of anisotropically absorbing expansion and shrinkage of the active material layer with copper foil provided with the pores. However, regarding the collector provided with such pores, the area of the portion formed from the metal material is reduced and, therefore, it is believed that the strength is reduced as compared with the strength of the collector provided with no pores. Moreover, the collector area is reduced and, therefore, problems, e.g., reduction in current collecting effect and an increase in resistance, are considered.

The notches disposed in the collector in Japanese Unexamined Patent Application Publication No. 7-192726 have a function to relieve a stress in formation of the active material layer. However, for example, elongation may occur in the individual regions divided by the notches because of the stress applied during use of the battery and, thereby, the collector in itself may take on a wavy shape. In this case, the adhesion between the positive electrode and the negative electrode is reduced and the battery performance is degraded. Furthermore, an effect of suppressing breakage of the collector is obtained, although the strength of the collector in itself trends toward reduction. Therefore, the collector in itself is deformed following the expansion and shrinkage of the active material layer and, as a result, another problem, e.g., expansion of the whole battery, may occur.

The present disclosure has been made in consideration of the above-described problems in related art, and it is desirable to provide a nonaqueous electrolyte battery in which damages and breakage of an electrode collector during production of the battery and during use of the battery may be suppressed, a rolled electrode assembly collector, a layer-built electrode assembly collector, and a method for manufacturing a nonaqueous electrolyte battery collector.

A nonaqueous electrolyte battery according to an embodiment of the present disclosure is provided with a rolled electrode assembly, in which a positive electrode and a negative electrode are stacked with a separator therebetween and are rolled, the positive electrode including a positive electrode active material layer containing a positive electrode active material and being disposed on the surface of a positive electrode collector formed from metal foil, the negative electrode including a negative electrode active material layer containing a negative electrode active material and being disposed on the surface of a negative electrode collector formed from metal foil, and the separator insulating the positive electrode from the negative electrode and an electrolyte, wherein at least one of the positive electrode collector and the negative electrode collector has a compressed pattern portion, which is disposed as a part of the metal foil and which has a thickness smaller than the thickness of the other portion through compression, and the compressed pattern portion from one end parallel to the rolling direction of the metal foil to the other end opposite to the one end is not disposed continuously in the direction orthogonal to the rolling direction of the metal foil.

A nonaqueous electrolyte battery according to an embodiment of the present disclosure is provided with an electrode assembly, in which a positive electrode and a negative electrode are stacked with a separator therebetween, the positive electrode including a positive electrode active material layer containing a positive electrode active material and being disposed on the surface of a positive electrode collector formed from metal foil, the negative electrode including a negative electrode active material layer containing a negative electrode active material and being disposed on the surface of a negative electrode collector formed from metal foil, and the separator insulating the positive electrode from the negative electrode and an electrolyte, wherein at least one of the positive electrode collector and the negative electrode collector has a compressed pattern portion which is disposed as a part of the metal foil and which has a thickness smaller than the thickness of the other portion through compression, and the compressed pattern portion is not disposed continuously in the directions of two groups of opposite sides of the metal foil.

A rolled electrode assembly collector according to an embodiment of the present disclosure includes a compressed pattern portion, which is disposed as a part of a band-shaped metal foil and which has a thickness smaller than the thickness of the other portion through compression, wherein the compressed pattern portion is not disposed continuously in the short-side direction of the metal foil.

A layer-built electrode assembly collector according to an embodiment of the present disclosure includes a compressed pattern portion, which is disposed as a part of a rectangular metal foil and which has a thickness smaller than the thickness of the other portion through compression, wherein the compressed pattern portion is not disposed continuously in the directions of two groups of opposite sides of the metal foil.

A method for manufacturing a nonaqueous electrolyte battery collector, according to an embodiment of the present disclosure, includes subjecting metal foil to a press treatment by a metal roll provided with an uneven pattern having a shape not continued from one end of the metal foil to the other end opposite to the one end, so as to form a compressed pattern portion corresponding to the uneven pattern of the metal roll and having a thickness smaller than the thickness of the other portion, as a part of the metal foil.

Regarding the collector used for the rolled electrode assembly and the layer-built electrode assembly according to embodiments of the present disclosure, the yield strength may be improved without impairing the ductility of the collector significantly.

In the case where the collector according to embodiments of the present disclosure is used, damages and breakage of the collector during production of the battery and those resulting from expansion, shrinkage, and the like of the active material layer along with charge and discharge may be suppressed.

Additional features and advantages are described herein, and will be apparent from the following Detailed Description and the figures.

### BRIEF DESCRIPTION OF THE FIGURES

FIG. 1 is a perspective view showing a configuration example of a collector according to an embodiment of the present disclosure;

FIGS. 2A and 2B are schematic diagrams showing examples of the shape of a compressed pattern portion disposed in a collector according to an embodiment of the present disclosure;

FIGS. 3A and 3B are schematic diagrams showing examples of the shape of a compressed pattern portion disposed in a collector according to an embodiment of the present disclosure;

FIGS. 4A and 4B are schematic diagrams showing examples of the shape of a compressed pattern portion disposed in a collector according to an embodiment of the present disclosure;

FIGS. 5A and 5B are schematic diagrams showing examples of the shape of a compressed pattern portion disposed in a collector according to an embodiment of the present disclosure;

FIG. 6 is a sectional view showing an example of the cross-sectional configuration of a collector according to an embodiment of the present disclosure;

FIG. 7 is a top view showing another configuration example of a collector according to an embodiment of the present disclosure;

FIGS. 8A and 8B are top views showing configuration examples of a collector, to which embodiments according to the present disclosure are applied.

FIG. 9 is a sectional view showing a method for manufacturing a collector, according to an embodiment of the present disclosure;

FIGS. 10A to 10F are sectional views showing a method for manufacturing an emboss roll, which is a compressed member to produce a collector according to an embodiment of the present disclosure;

FIG. 11 is a sectional view showing a configuration example of a nonaqueous electrolyte battery by using a collector according to an embodiment of the present disclosure;

FIG. 12 is a sectional view showing a configuration example of a rolled electrode assembly by using a collector according to an embodiment of the present disclosure;

FIGS. 13A to 13C are perspective views showing a configuration example of a nonaqueous electrolyte battery by using a collector according to an embodiment of the present disclosure;

FIGS. 14A to 14C are perspective views and a sectional view showing a configuration example of an electrode and a layer-built electrode assembly by using a collector according to an embodiment of the present disclosure;

FIG. 15 is a sectional view showing a configuration example of an outer case member of a nonaqueous electrolyte battery by using a collector according to an embodiment of the present disclosure;

FIG. 16 is a block diagram showing a configuration example of a battery pack by using a nonaqueous electrolyte battery according to an embodiment of the present disclosure;

FIG. 17 is a schematic diagram showing an example of a housing electricity storage system by using a nonaqueous electrolyte battery according to an embodiment of the present disclosure;

FIG. 18 is a schematic diagram showing an example of the configuration of a hybrid vehicle adopting a series hybrid system by using a nonaqueous electrolyte battery according to an embodiment of the present disclosure;

FIGS. 19A and 19B are a top view and a sectional view, respectively, showing the configuration of Example 1-1.

FIG. 20 is a top view showing the shape of a test collector of the example.

FIGS. 21A and 21B are a top view and a sectional view, respectively, showing the configuration of Example 1-2.

FIGS. 22A and 22B are a top view and a sectional view, respectively, showing the configuration of Comparative example 1-3.

FIG. 23 is a graph showing the evaluation results of Example 1.

FIGS. 24A and 24B are top views showing the configuration of Example 2-1.

FIGS. 25A and 25B are top views showing the configuration of Example 2-2.

FIG. 26 is a top view showing a testing method of Example 2.

FIG. 27 is a graph showing the evaluation results of Example 2.

FIG. 28 is a top view showing a testing method of Example 3.

FIG. 29 is a graph showing the evaluation results of Example 3.

### DETAILED DESCRIPTION

The embodiments according to the present disclosure (hereafter referred to as embodiments) will be described below. In this regard, explanations will be made in the following order.

1. First embodiment (example of collector according to embodiment of the present disclosure)
2. Second embodiment (example of cylindrical battery by using collector according to embodiment of the present disclosure)
3. Third embodiment (example of layer-built battery by using collector according to embodiment of the present disclosure)
4. Fourth embodiment (example of battery pack)
5. Fifth embodiment (example of electricity storage system and the like by using battery)

### 1. First Embodiment

A collector according to a first embodiment is used for, for example, a positive electrode and a negative electrode to constitute a battery, e.g., a lithium ion secondary battery.

### (1-1) First Configuration of Collector

Configuration of Collector

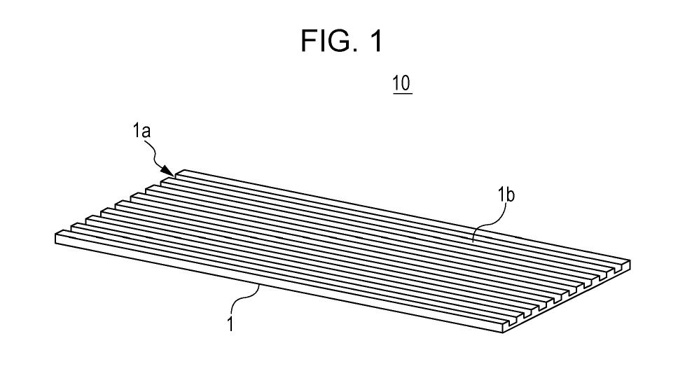

FIG. 1 shows a first configuration example of a collector 10 according to a first embodiment of the present disclosure. The collector 10 is formed from metal foil 1 and a compressed pattern portion 1a, which has a thickness smaller than the thickness of the other portion, is disposed as a part of the metal foil 1. Among the metal foil 1, an uncompressed pattern portion 1b, in which the compressed pattern portion 1a is not disposed, is brought into an uncompressed state or a weakly compressed state. A plastic strain occurs in the metal foil 1 by disposing the compressed pattern portion 1a in the metal foil 1, and a three-dimensional shape composed of a strongly compressed portion and an uncompressed portion or a weakly compressed portion is formed in accordance with an uneven pattern including the compressed pattern portion 1a and the uncompressed pattern portion 1b. In this regard, FIG. 1 shows the collector 10 provided with the straight-line shaped compressed pattern portion 1a continuing in the longitudinal direction of the metal foil 1, on the rectangular metal foil 1. This configuration is one example, and the shapes of the metal foil 1 and the compressed pattern portion 1a are not limited to this.

In general, regarding the metal foil, in the case where a plastic strain occurs due to compression, the yield strength increases through work hardening, but at the same time, embrittlement proceeds. Consequently, the tensile strength increases due to an increase in yield strength through work hardening, whereas the elongation after fracture is reduced due to proceeding of embrittlement, so that breakage occurs easily. According to an embodiment of the present disclosure, the compressed pattern portion 1a accompanied with hardening and embrittlement is dispersedly disposed on the metal foil 1 not accompanied with hardening and embrittlement and, thereby, the yield strength may be improved without impairing the ductility of the whole collector 10.

As for the metal foil 1, a metal material having corrosion resistance to an electrolyte may be used. Examples of such metal materials may include aluminum (Al), copper (Cu), nickel (Ni), and stainless steel (SUS). In the case where the metal foil 1 is used as a positive electrode collector, it is preferable that a metal material having corrosion resistance in a highly oxidizing environment is used, and in particular, it is preferable that aluminum (Al) is used. The metal foil 1 may be a rolled material, or be a non-rolled material. This is because further improvement in yield strength is expected by disposing the compressed pattern portion 1a.

It is preferable that aluminum (Al) constituting the metal foil 1 is, for example, mild aluminum (Al) after being subjected to an annealing treatment, and more preferably is a non-rolled material. Concretely, materials, e.g., A8021H-O, A1085H-O, A1N30-O, and A3003H-O, on the basis of JIS may be used, for example.

The thickness of the metal foil 1 may be set at a thickness suitable for obtaining desired strength and stretchability. In the case where the metal foil is used for a battery collector, 5 μm or more and 100 μm or less is preferable. If the metal foil 1 is thin and the thickness is out of the above-described range, the strength is low and the metal foil 1 is broken easily. If the metal foil 1 is thick and the thickness is out of the above-described range, the proportion of the volume of the collector 10 in the battery becomes large, and the battery capacity is reduced. In this regard, the thickness of the metal foil 1 for the collector is not limited to the above-described thickness and may be selected appropriately in accordance with the battery configuration. For example, in the case where the metal foil 1 is used for a large battery having a high capacity, the metal foil 1 having a thickness larger than the above-described range may be used.

### Compressed Pattern Portion

The shape of the compressed pattern portion 1a may be any shape insofar as a three-dimensional shape composed of a strongly compressed portion and an uncompressed portion or a weakly compressed portion is formed on the collector 10. In particular, in the case where it is desired to increase the yield strength in some direction, the compressed pattern portion 1a having a shape, in which the main direction is the desired direction, is disposed. However, it is preferable at least that the compressed pattern portion 1a is not disposed continuously in a direction orthogonal to the direction in which an increase in yield strength of the collector 10 is desired. In particular, the compressed pattern portion 1a is disposed continuously in a direction parallel to the direction, in which an increase in yield strength of the collector 10 is desired, and is not disposed continuously from one end parallel to the direction, in which an increase in yield strength of the collector 10 is desired, to the other end opposite to the one end.

The metal foil 1 used as the base material of the collector 10 has a very small thickness. Therefore, in the case where a tensile stress is applied, cracking tends to occur in a direction orthogonal to the tensile direction where the base point is a fine defect generated at an end portion of the metal foil 1 during the cutting or the like. Consequently, the collector 10, in which the compressed pattern portion 1a is disposed while being continuously ranged in the direction orthogonal to the tensile direction of the metal foil 1, is broken easily because cracking proceeds along the compressed pattern portion 1a. In particular, in the case where the compressed pattern portion 1a is disposed up to one end or both ends parallel to the tensile direction of the metal foil 1, the compressed pattern portion 1a may serve as a starting point of cracking. From these reasons, it is preferable that the shape and the direction of formation of the compressed pattern portion 1a are selected appropriately in accordance with the battery shape.

In the case where the collector 10 is used for a battery provided with a rolled electrode assembly, it is considered that the direction, in which an increase in yield strength is desired, is the rolling direction of the electrode by using the collector 10. The rolled electrode assembly refers to, for example, an electrode assembly produced by stacking a positive electrode and a negative electrode formed into the shape of a band and performing rolling in the longitudinal direction. Regarding the rolled electrode assembly, the band-shaped collector 10 follows expansion and shrinkage of an active material layer in both the longitudinal direction and the short-side direction. However, the rolling structure is employed and, thereby, volume expansion of the active material layer functions as a larger tensile stress in the rolling direction of the collector 10. Consequently, in the case where the collector 10 is used for a battery provided with the rolled electrode assembly, it is preferable that the compressed pattern portion 1a, which has the main direction of continuity parallel to the rolling direction and which is in the shape having anisotropy, is disposed. According to this, the yield strength in both directions of the rolling direction and the direction orthogonal to the rolling direction may be increased and, in addition, particularly in the rolling direction, the yield strength may be increased significantly.

Furthermore, in the case where the collector 10 is used for a battery provided with a rolled electrode assembly, the rolling direction is the tensile direction. Therefore, the compressed pattern portion 1a is not disposed continuously in the direction orthogonal to the rolling direction of the collector 10, that is, in the short-side direction of the electrode in almost all cases.

In the case where the collector 10 is used for a battery provided with a layer-built electrode assembly, it is considered that the direction, in which an increase in yield strength is desired, is the direction of opposite sides of the collector 10. The layer-built electrode assembly refers to, for example, an electrode assembly produced by stacking a positive electrode and a negative electrode formed into a rectangular shape and performing fixing, as necessary. Regarding the layer-built electrode assembly, in contrast to the above-described rolled electrode assembly, it is believed that a large tensile stress in one direction resulting from the configuration of the electrode assembly hardly acts. That is, regarding the layer-built electrode assembly, nearly equal tensile stresses are generated in accordance with expansion and shrinkage of an active material layer in directions of two groups of opposite sides (nearly orthogonal two directions) of the rectangular collector 10. Consequently, in the case where the collector 10 is used for a battery provided with the layer-built electrode assembly, it is preferable that the compressed pattern portion 1a, which improves the yield strength in all directions equally, that is, which is in the shape not having anisotropy, is disposed.

In the case where the collector 10 is used for a battery provided with a layer-built electrode assembly, the directions of two groups of opposite sides are tensile directions. Therefore, the compressed pattern portion 1a is not disposed continuously in at least the directions of two groups of opposite sides.

Examples of the shapes of the compressed pattern portion 1a include a linear shape disposed continuously or intermittently in one direction or a geometric shape disposed dispersedly. Here, examples of the geometric shapes include various shapes, such as, a circular shape, an elliptical shape, polygonal shapes, e.g., a triangular shape, a rhombic shape, a trapezoidal shape, and a semicircular shape. However, the shape which does not undergo a stress locally during formation of the compressed pattern portion 1a is preferable. Concretely, the shape having a smaller number of corners is preferable, and a circular shape, an elliptical shape, a polygonal shape, and the like are used favorably.

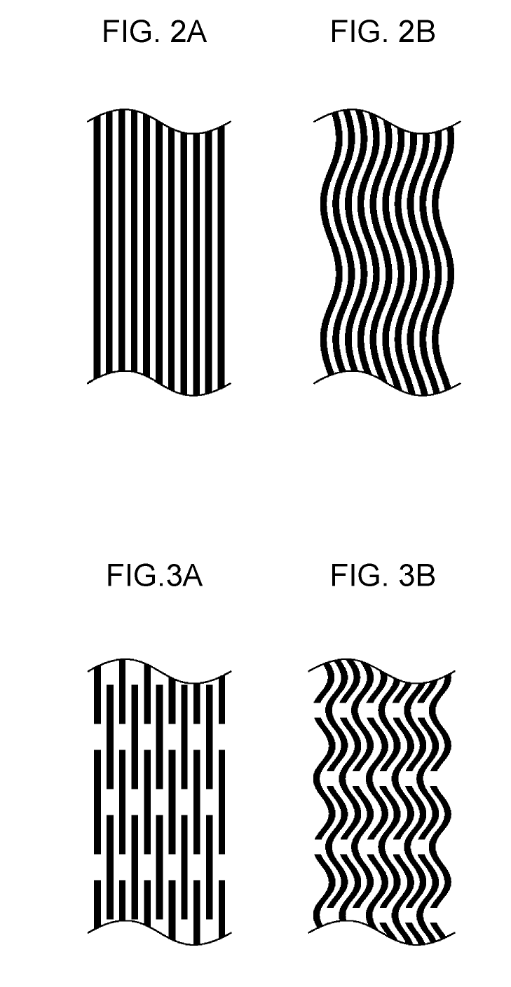

As for the shape disposed continuously in one direction, a parallel stripe shape or a nearly stripe shape is preferable, in which the individual compressed areas are disposed in such a way as not to intersect with each other. Here, the nearly stripe shape refers to the shape in which the individual compressed areas are not strictly in a straight-line shape, but average lines thereof are parallel to one direction and the curved lines do not intersect with each other. Examples of such shapes include a straight-line shape shown in FIG. 2A and a curved-line shape shown in FIG. 2B. In this regard, in FIG. 2A and FIG. 2B, the portions indicated by black are compressed pattern portions 1a which are portions formed having thicknesses smaller than those of the portions indicated by white through compression. The same goes for the following drawings which show the shapes of the compressed pattern portions 1a.

In the case where the compressed pattern portion 1a is formed into the shape which is disposed continuously in one direction, the widths of the individual compressed areas and the pitches of the compressed areas may be set arbitrarily. However, formation is performed preferably in such a way that the widths of the individual compressed areas are 10 μm or more and 100 μm or less, and the pitches of the compressed areas are about 50 μm or more and 500 μm or less. This is because an effect of improving the yield strength of the collector 10 and, in addition, an effect of improving the peeling strength of the active material layer disposed on the collector 10 may be obtained by forming the compressed pattern portion 1a having small widths of the individual compressed areas and fine pitches. This is because the active material layer is formed while entering the compressed pattern portion 1a and, thereby, a so-called anchor effect is exerted.

It is preferable that such a compressed pattern portion 1a formed into the shape, which is disposed continuously in one direction, is applied particularly to the rolled electrode assembly. In this case, the direction of continuity of the straight-line shape, a curved-line shape, or the like of the compressed pattern portion 1a is the rolling direction of the collector 10.

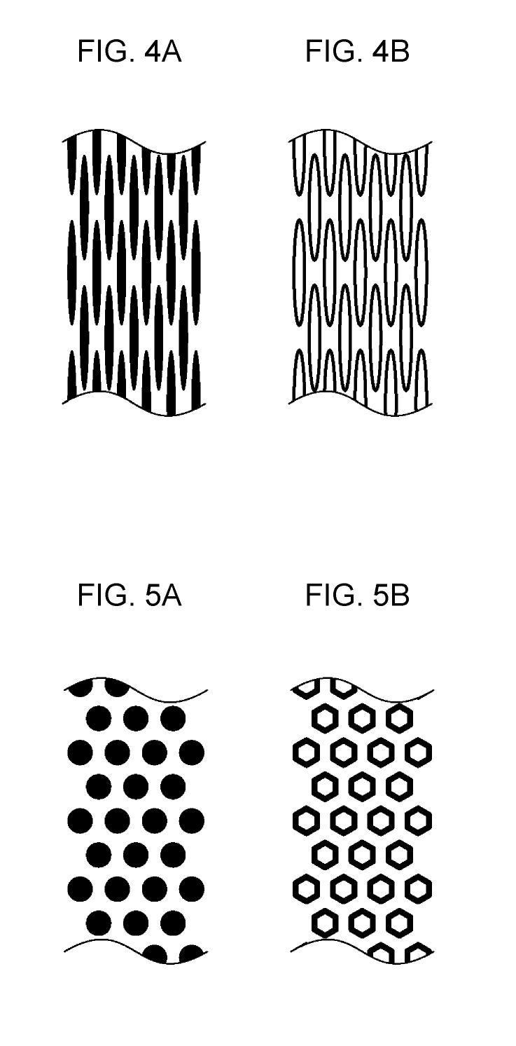

Examples of the shapes disposed intermittently in one direction include an intermittent straight-line shape shown in FIG. 3A and an intermittent curved-line shape shown in FIG. 3B. In the case where the compressed pattern portion 1a is formed into the shape which is disposed intermittently in one direction, the widths of the individual compressed areas and the pitches of the compressed areas may be specified to be the same as those of the shape in which the compressed pattern portion 1a is disposed continuously in one direction.

It is preferable that such a compressed pattern portion 1a formed into the shape, which is disposed intermittently in one direction, is applied particularly to the rolled electrode assembly. In this case, the direction of continuity of the intermittent straight-line shape, the intermittent curved-line shape, or the like of the compressed pattern portion 1a is the rolling direction of the collector 10.

The compressed pattern portion 1a in the shape formed continuously or intermittently in one direction is disposed in such a way that the individual compressed areas are not formed continuously in the direction orthogonal to the tensile direction and, thereby, cracking does not proceed easily in the direction orthogonal to the tensile direction. Consequently, the collector 10 making use of both the high yield strength of the compressed pattern portion 1a and the high ductility of the uncompressed portion or the weakly compressed portion may be obtained.

As for the geometric shape disposed dispersedly, both the shape having anisotropy and the shape not having anisotropy may be employed. Among the geometric shapes disposed dispersedly, examples of shapes having anisotropy include the elliptical shape shown in FIG. 4A. Alternatively, the elliptical shape shown in FIG. 4B, in which the outline portion of an ellipse is compressed and the central portion is an uncompressed pattern portion 1b, may be employed.

It is preferable that the compressed pattern portion 1a in the shape having anisotropy, among such geometric shapes disposed dispersedly, is applied particularly to the rolled electrode assembly. In this case, the longitudinal direction of the geometric shape having anisotropy of the compressed pattern portion 1a is the rolling direction of the collector 10.

Examples of shapes not having anisotropy, among the geometric shapes disposed dispersedly, include the circular shape shown in FIG. 5A and the hexagonal shape shown in FIG. 5B. Regarding the circular shape shown in FIG. 5A, only the outline portion may be the compressed pattern portion 1a in the same manner as the hexagonal shape shown in FIG. 5B. Meanwhile, regarding the hexagonal shape shown in FIG. 5B, not only the outline portion, but also all over the hexagonal shape may be the compressed pattern portion 1a in the same manner as the circular shape shown in FIG. 5A.

It is preferable that the compressed pattern portion 1a in the shape not having anisotropy, among such geometric shapes disposed dispersedly, is applied particularly to the layer-built electrode assembly. In this case, the compressed pattern portion 1a in the geometric shape not having anisotropy is disposed dispersedly and, thereby, the yield strength of the collector 10 may be improved isotropically.

Even in the case where the compressed pattern portion 1a in the shape not having anisotropy, among the geometric shapes disposed dispersedly, is disposed, application to the rolled electrode assembly is also possible by adjusting the dispersion state of the compressed pattern portion 1a. For example, the compressed pattern portion 1a, in which the geometric shape not having anisotropy is dispersed densely in the rolling direction of the collector 10 and is dispersed coarsely in the direction orthogonal to the rolling direction as compared with that in the rolling direction, may improve the yield strength in the rolling direction of the collector 10 as a whole.

Regarding the compressed pattern portion 1a in the geometric shape disposed dispersedly, the individual compressed areas are not ranged in any direction and, therefore, the yield strength is somewhat low as compared with that in the case where the compressed pattern portion 1a in the above-described shape disposed continuously or intermittently in one direction is formed. However, the collector 10 which is not broken easily may be obtained.

The compressed pattern portion 1a has high yield strength, but low ductility as compared with the uncompressed pattern portion 1b. Therefore, as the total area of the compressed pattern portion 1a constituting the metal foil 1 increases, the yield strength increases, and as the total area of the compressed pattern portion 1a constituting the metal foil 1 decreases, the ductility increases. Consequently, the total area of the compressed pattern portion 1a may be selected appropriately on the basis of the priority between the yield strength and the ductility. However, in consideration of the balance between the yield strength and the ductility, 5% or more and 95% or less relative to the total area of the metal foil 1 is preferable.

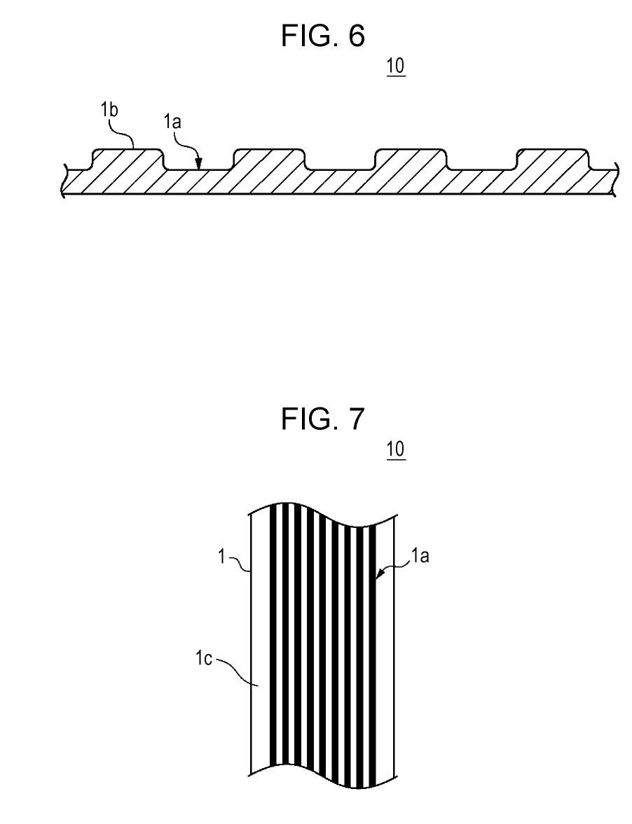

Meanwhile, as shown in FIG. 6, it is preferable that the collector 10 has a cross-sectional shape in which the compressed pattern portion 1a and the uncompressed pattern portion 1b are ranged having a curvature. In the case where the cross-sectional shape of the metal foil 1 has a corner portion, when a tensile stress is applied to the metal foil 1, the stress may be concentrated on the corner portion, so as to cause breakage of the metal foil 1.

In this regard, FIG. 6 shows the configuration in which the compressed pattern portion 1a is disposed on one surface of the metal foil 1. However, the compressed pattern portion 1a may be formed by performing compression from both surfaces of the metal foil 1.

### (1-2) Second Configuration of Collector

FIG. 7 shows a second configuration example of the collector 10 according to the first embodiment of the present disclosure. In the collector 10 of the second configuration example, a region 1c provided with no compressed pattern, in which the compressed pattern portion 1a is not formed, is disposed at an end portion of the metal foil 1 and the same compressed pattern portion 1a as that in the first configuration is disposed at the portion excluding the end portion of the metal foil 1.

In the collector 10 used for the rolled electrode assembly, it is preferable that the regions 1c provided with no compressed pattern are disposed at both ends parallel to the rolling direction of the collector 10. In regions in the vicinity of the end portion parallel to the tensile direction, cracking occurs easily. Therefore, proceeding of cracking from the end portion may be further suppressed by forming the compressed pattern portion 1a, which has high brittleness as compared with the other portion, in regions excluding the region in the vicinity of the end portion in which cracking occurs easily. Moreover, a region excellent in ductility is continuously ensured in the region in the vicinity of the end portion and, thereby, the collector 10 may not be broken easily as a whole.

In the collector 10 used for the layer-built electrode assembly, it is preferable that the region 1c provided with no compressed pattern is disposed in the vicinity of all end portions of the metal foil 1.

It is preferable that the region 1c provided with no compressed pattern is disposed having a width at a predetermined proportion relative to the width of the metal foil 1. Concretely, the width of the region 1c provided with no compressed pattern relative to the width of the metal foil 1 is preferably specified to be within the range of 5% or more and 40% or less, and more preferably is specified to be within the range of 10% or more and 20% or less. This is because if the width of the region 1c provided with no compressed pattern is small and out of the above-described range, the effect of disposing the region 1c provided with no compressed pattern is not obtained easily. Furthermore, this is because if the width of the region 1c provided with no compressed pattern is large and out of the above-described range, contribution of the collector 10 to the ductility is hardly changed and a reduction in yield strength occurs.

### (1-3) Modified Example

A collector 11 of Modified example described below has a certain level of collector breakage preventing effect, although the shape of a compressed pattern portion 12a is different from the shapes of the compressed pattern portions 1a of the above-described first and second configuration examples.

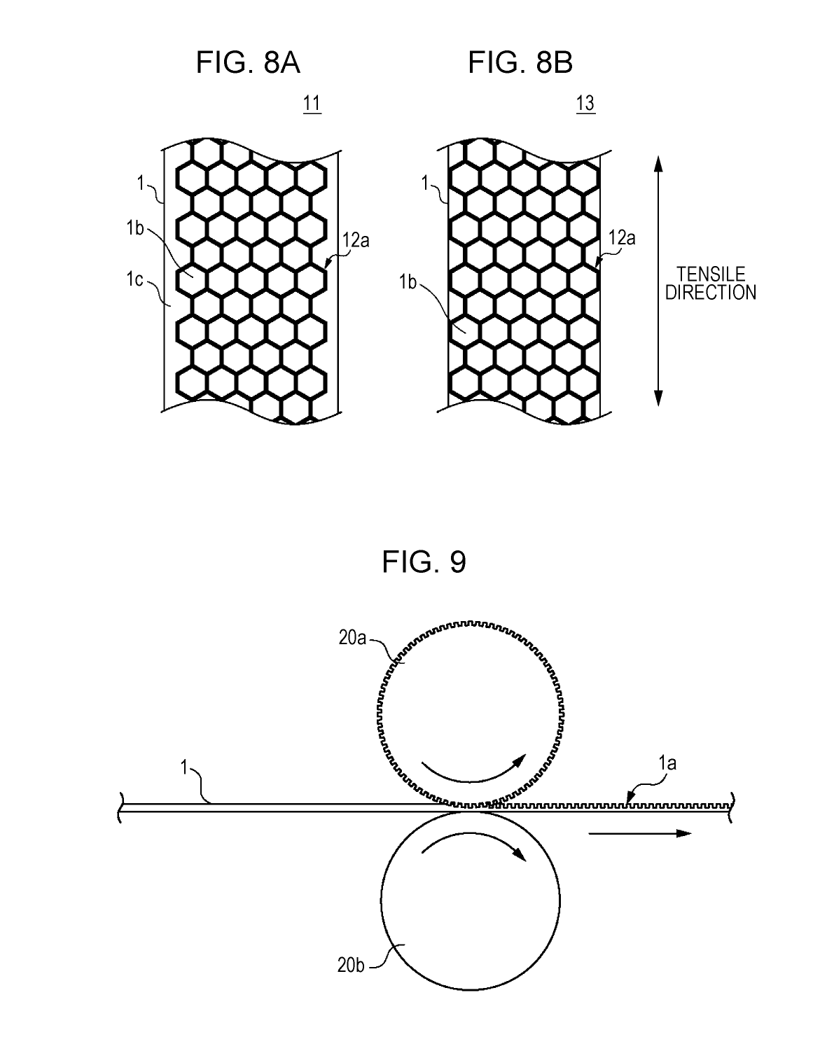

FIG. 8A shows the collector 11 of Modified example. The collector 11 includes the compressed pattern portion 12a, which is disposed as a part of the metal foil 1 and which has a thickness smaller than the thickness of the other portion through compression. Among the metal foil 1, an uncompressed pattern portion 1b, in which the compressed pattern portion 12a is not disposed, is brought into an uncompressed state or a weakly compressed state in the same manner as in the first configuration. In the following explanation, the configuration in the case where the collector 11 is used for the rolled electrode assembly (in the case where a tensile stress is applied in one direction) will be described.

As shown in FIG. 8A, in the collector 11 of Modified example, a compressed area is disposed continuously in the direction orthogonal to the rolling direction of the collector 11 and, in addition, in the same manner as in the second configuration example, regions 1c provided with no compressed pattern are disposed in the vicinity of both end portions parallel to the tensile direction of the metal foil 1. FIG. 8A shows the shape, as an example of the compressed pattern portion 12a, in which hexagonal compressed areas are continued, although the shape of the compressed pattern portion 12a is not limited to this.

FIG. 8B shows an example of a collector 13 in which the compressed pattern portion 12a is made into the shape of continuous hexagonal compressed areas, that is, the honeycomb shape, and which is different from the present disclosure. In the collector 13 shown in FIG. 8B, the compressed pattern portion 12a is disposed all over the surface of the metal foil 1 and the compressed areas having high brittleness are disposed up to the end portion of the metal foil 1. Consequently, cracking occurs easily in the compressed pattern portion 12a disposed at the end portion of the metal foil 1 and cracking proceeds in the compressed pattern portion 12a, so that the collector 13 is broken easily.

Meanwhile, in the case where the regions 1c provided with no compressed pattern are disposed in the vicinity of both end portions parallel to the tensile strength of the metal foil 1, as shown in FIG. 8A, cracking at the end portion, which serves as a start of breakage of the collector 11, does not occur easily. Consequently, even in the case where the compressed pattern portion 12a is in the shape continuing in the direction orthogonal to the tensile direction as in the collector 11, the breakage preventing effect of the collector 11 is enhanced.

### (1-4) Method for Manufacturing Collector

The compressed pattern portion 1a is obtained by compressing a predetermined portion of the metal foil 1 with a press or the like. Most of all, as shown in FIG. 9, it is preferable to compress the metal foil 1 through roll press of a so-called roll to roll system, in which two cylindrical rolls are rotated relatively and the compressed pattern portion 1a is disposed on the metal foil 1 by passing the metal foil 1 between the rolls. In this case, at least one of the rolls is specified to be an emboss roll 20a provided with a predetermined uneven shape corresponding to the compressed pattern portion 1a on the surface and, thereby, the metal foil 1 is compressed. The other roll not provided with an uneven shape is specified to be a back roll 20b formed in such a way that roll press is performed favorably. In this regard, FIG. 9 shows a roll press treatment simply for the purpose of explanation, and an actual uneven pattern provided on the emboss roll 20a and the like is different from that shown in the drawing.

As described above, the metal foil 1 is compressed by the press or the like and, thereby, plastic strain is generated at the surface of the metal foil 1 and a three-dimensional shape composed of a strongly compressed portion and an uncompressed portion or a weakly compressed portion is formed in accordance with an uneven pattern of the emboss roll 20a. That is, a worked pattern formed by subjecting the metal foil 1 to laser machining or an etching treatment directly has the same configuration as that of the present disclosure in the point that a part of the metal foil 1 is formed having a thickness smaller than the thickness of the other portion, but is different from the present disclosure in the point that work hardening through compression is not effected. In the case where a portion in which work hardening has occurred is not included, the strength of the collector is reduced because merely the thickness of the portion subjected to the laser machining or the etching treatment is reduced and the yield strength is not improved. A portion formed having a small thickness through compression, as in the embodiments according to the present disclosure, has differences in crystal structure, e.g., a relatively high dislocation density and a relatively small crystal grain size, as compared with other uncompressed portion. The differences may be ascertained with an electron microscope or the like.

The roll press to form the compressed pattern portion 1a is preferable because higher yield strength is given to the collector 10 through execution at room temperature. The roll press may be executed by using the emboss roll 20a and the back roll 20b heated appropriately. In this case, the yield strength of the collector is slightly reduced and, in addition, the ductility is improved.

The above-described roll press is preferable because it is possible to constitute a series of processes in combination with application of an active material mix to the collector 10. The process may be simplified by applying the active material mix to the collector 10 in succession to the above-described formation of the compressed pattern portion 1a.

The surface of the emboss roll 20a provided with the predetermined uneven shape corresponding to the compressed pattern portion 1a on the surface is formed from a material having a hardness higher than the hardness of the metal foil 1 serving as the base material for the collector 10. As for the method for forming the uneven surface of the emboss roll 20a, a working method in related art selected in accordance with the material constituting the emboss roll 20a may be employed. As for the working method, for example, cutting tool machining, laser machining, an etching treatment, and the like are employed favorably.

It is preferable that the back roll 20b disposed opposite to the emboss roll 20a has a cylindrical shape or a crown shape with the intention of leveling the linear pressure during pressing. Furthermore, it is preferable that the surface of the back roll 20b has a surface hardness capable of giving an appropriate pressure to the metal foil 1. Concretely, the back roll 20b may be formed from iron or have a configuration in which an elastic resin layer is formed on the surface.

A method for forming the emboss roll 20a will be described below.

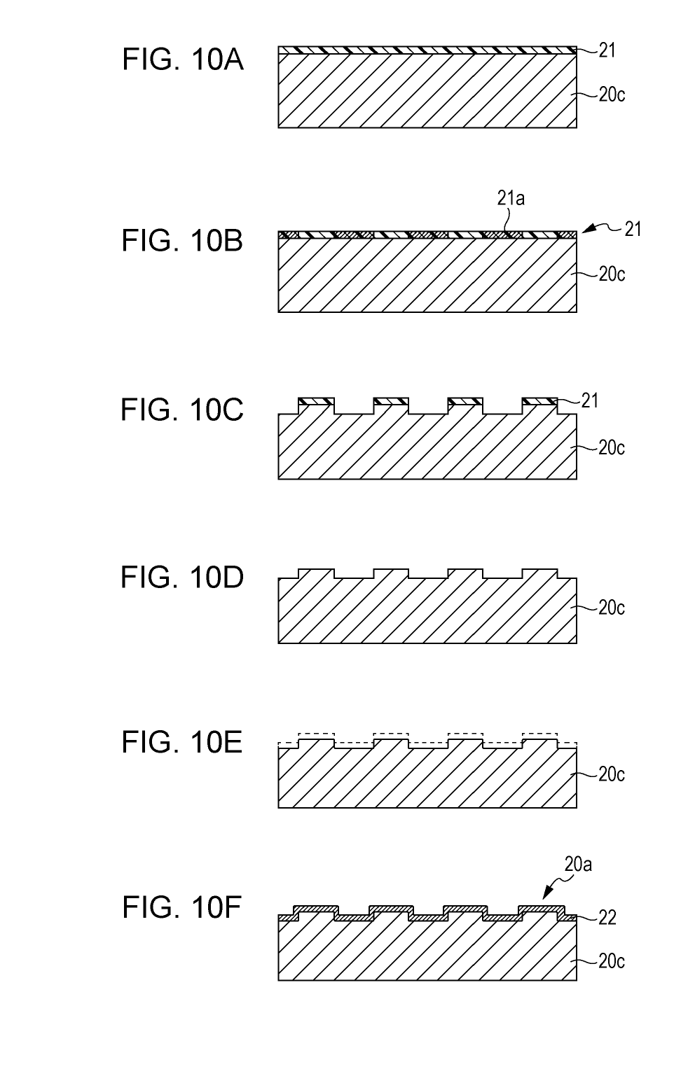

As shown in FIG. 10A, a mask 21 composed of a resist film is formed on a roll base material 20c which is a member to be worked and the surface of which is plated with copper. As shown in FIG. 10B, an exposure pattern 21a in a desired shape is formed on the mask 21 by laser drawing. The shape of the exposure pattern 21a formed on the mask 21 is specified to be a shape corresponding to the uneven shape of the compressed pattern portion 1a to be formed on the collector 10.

As shown in FIG. 10C, a wet etching treatment is applied to the exposure pattern 21a formed on the mask 21, so as to etch the portion of the exposure pattern 21a and form the uneven shape having a rectangular cross-section. Thereafter, as shown in FIG. 10D, all the remaining mask 21 is peeled through ashing or the like.

As shown in FIG. 10E, the surface of the roll 20 is subjected to the etching treatment again. Consequently, a smooth uneven shape, in which the cross-sectional shape has no corner portion and which is ranged having a curvature, is formed. The desired uneven shape is formed by the two times of wet etching treatment, as described above, and thereafter, as shown in FIG. 10F, a surface layer 22 is formed by plating the roll surface with, for example, a high-hardness metal material, e.g., hard chromium. In this manner, the emboss roll 20a to form the collector 10 may be obtained.

### 2. Second Embodiment

In a second embodiment, an example of a nonaqueous electrolyte battery provided with a rolled electrode assembly will be described.

### (2-1) Whole Configuration of Nonaqueous Electrolyte Battery

Structure of Nonaqueous Electrolyte Battery

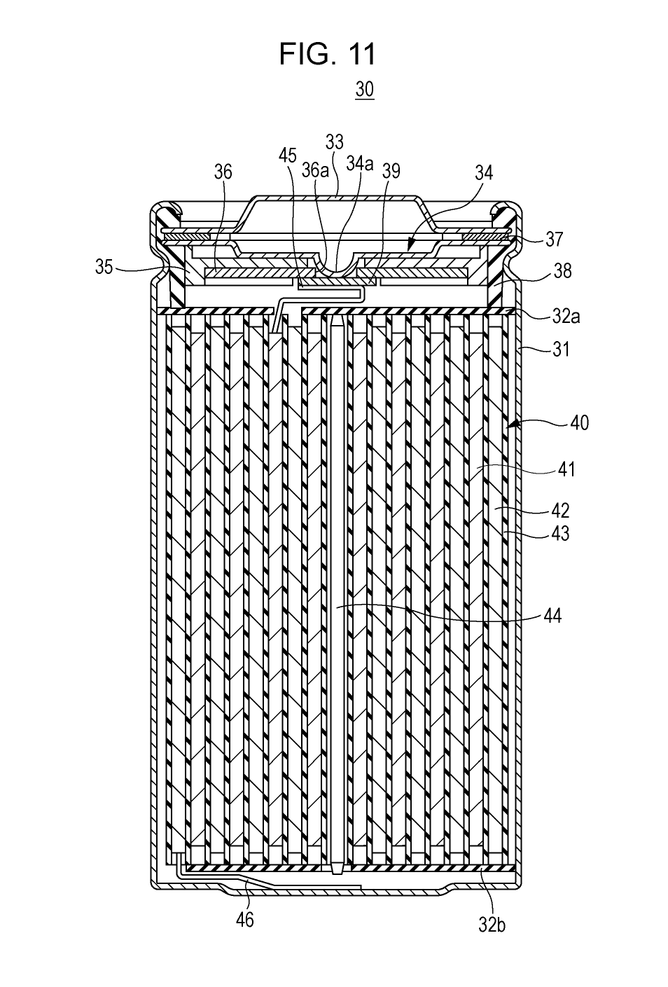

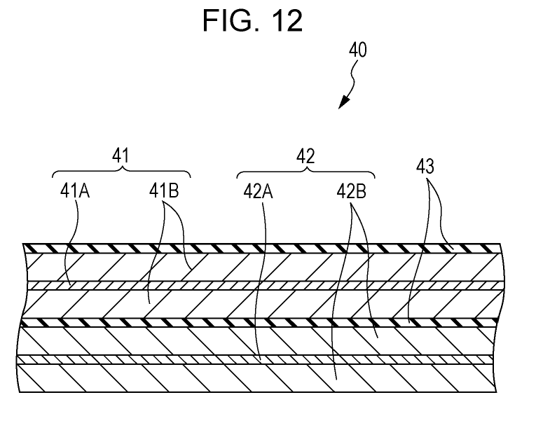

FIG. 11 is a sectional view showing an example of a nonaqueous electrolyte battery 30 according to the second embodiment. This battery is a so-called cylindrical battery and includes a rolled electrode assembly 40, in which band-shaped positive electrode 41 and negative electrode 42 are rolled with a separator 43 therebetween, along with a nonaqueous electrolytic solution, although not shown in the drawing, in the inside of a nearly hollow circular columnar battery can 31. The battery can 31 is formed from, for example, iron provided with nickel plating, and one end portion is closed and the other end portion is opened. In the inside of the battery can 31, a pair of insulating plates 32a and 32b are disposed perpendicularly to a rolling circumferential surface in such a way as to sandwich the rolled electrode assembly 40 therebetween.

Examples of materials for the battery can 31 include iron (Fe), nickel (Ni), stainless steel (SUS), aluminum (Al), and titanium (Ti). This battery can 31 may be subjected to plating with nickel or the like in order to prevent electrochemical corrosion with the nonaqueous electrolytic solution along with charge and discharge of the battery. A battery lid 33 serving as a positive electrode lead plate and a safety valve mechanism and a positive temperature coefficient element (PTC element) 37, which are disposed on the inner side of this battery lid 33, are attached to the open end portion of the battery can 31 by swaging with a gasket 38 for insulation and sealing therebetween.

The battery lid 33 is formed from, for example, the same material as the material for the battery can 31, and an opening portion to discharge a gas generated in the inside of the battery is disposed. In the safety valve mechanism, a safety valve 34, a disk holder 35, and an interrupting disk 36 are stacked sequentially. A protrusion portion 34a of the safety valve 34 is connected to a positive electrode lead 45 led from a rolled electrode assembly 40 through a subdisk 39 arranged in such a way as to cover a hole portion 36a disposed in the central portion of the interrupting disk 36. The safety valve 34 and the positive electrode lead 45 are connected with the subdisk 39 therebetween and, thereby, dragging of the positive electrode lead 45 from the hole portion 36a is prevented when the safety valve 34 is inverted. The safety valve mechanism is electrically connected to the battery lid 33 through the positive temperature coefficient element 37.

Regarding the safety valve mechanism, in the case where the internal pressure of the battery becomes a predetermined value or more because of internal short-circuit of the battery, heating from the outside of the battery, or the like, the safety valve 34 is inverted and, thereby, electrical connection between the protrusion portion 34a, the battery lid 33, and the rolled electrode assembly 40 is cut. That is, when the safety valve 34 is inverted, the positive electrode lead 45 is held down by the interrupting disk 36, and connection between the safety valve 34 and the positive electrode lead 45 is terminated. The disk holder 35 is formed from an insulating material, and in the case where the safety valve 34 is inverted, the safety valve 34 is insulated from the interrupting disk 36.

In the case where a gas is further generated in the inside of the battery, and the internal pressure of the battery further increases, a part of the safety valve 34 is cracked and the gas can be discharged to the battery lid 33 side.

For example, a plurality of vent holes (not shown in the drawing) are disposed around the hole portion 36a of the interrupting disk 36. In the case where a gas is generated from the rolled electrode assembly 40, the gas can be discharged to the battery lid 33 side efficiently.

When the temperature increases, the resistance value of the positive temperature coefficient element 37 increases, electrical connection between the battery lid 33 and the rolled electrode assembly 40 is cut so as to interrupt the current and, thereby, an occurrence of abnormal heat generation is prevented. The gasket 38 is formed from, for example, an insulating material and the surface is coated with asphalt.

The rolled electrode assembly 40 to be held in the nonaqueous electrolyte battery 30 is rolled about a center pin 44. A positive electrode 41 and a negative electrode 42 are stacked sequentially with a separator 43 therebetween and are rolled in the longitudinal direction, so that the rolled electrode assembly 40 is prepared. A positive electrode lead 45 is connected to the positive electrode 41, and a negative electrode lead 46 is connected to the negative electrode 42. As described above, the positive electrode lead 45 is welded to the safety valve 34 and, thereby, is electrically connected to the battery lid 33, and the negative electrode lead 46 is welded to the battery can 31 so as to be electrically connected.

### Positive Electrode

The positive electrode 41 is produced by forming positive electrode active material layers 41B containing a positive electrode active material on both surfaces of a positive electrode collector 41A, and is formed having a band-shape.

As for the positive electrode collector 41A, for example, metal foil, e.g., aluminum (Al) foil, nickel (Ni) foil, or stainless steel (SUS) foil, may be used. In the nonaqueous electrolyte battery 30 according to the second embodiment, the compressed pattern portion 1a explained in the first embodiment is disposed on the above-described metal foil in the same manner as that of the collector 10 according to the first embodiment, so that the positive electrode collector 41A is prepared. In the case where the compressed pattern portion 1a is disposed on one surface of the positive electrode collector 41A, the surface provided with the compressed pattern portion 1a may be either a surface facing the inside of the rolling of the rolled electrode assembly 40 or a surface facing the outside of the rolling.

The compressed pattern portion 1a disposed on the positive electrode collector 41A is specified to be in a shape formed continuously or intermittently in the longitudinal direction of the positive electrode collector 41A or a geometric shape which has anisotropy and which is formed dispersedly on the positive electrode collector 41A while the longitudinal direction of the geometric shape is nearly parallel to the longitudinal direction of the positive electrode collector 41A.

A positive electrode active material layer 41B is configured to contain, for example, a positive electrode active material, an electrically conductive agent, and a binder. The positive electrode active material layer 41B contains at least one type of positive electrode material, which can occlude and release lithium, as the positive electrode active material and, if necessary, may contain other materials, e.g., a binder and an electrically conductive agent.

As for the positive electrode material, which can occlude and release lithium, for example, a lithium-containing compound is preferable. This is because a high energy density is obtained. Examples of lithium-containing compounds include composite oxides containing lithium and a transition metal element and phosphates containing lithium and a transition metal element. Most of all, compounds containing at least one type selected from the group consisting of cobalt (Co), nickel (Ni), manganese (Mn), and iron (Fe) as the transition metal element is preferable. This is because a higher voltage is obtained.

As for the positive electrode material, for example, a lithium-containing compound represented by LiₓM1O₂ or Li_{y}M2PO₄ may be used. In the formulae, M1 and M2 represent at least one type of transition metal element. The values of x and y are different depending on the charge and discharge state of the battery, and usually satisfy 0.05≦x≦1.10 and 0.05<y<1.10. Examples of composite oxides containing lithium and a transition metal element include lithium cobalt composite oxides (LiₓCoO₂), lithium nickel composite oxides (Li_{y}NiO₂), lithium nickel cobalt composite oxides (LiₓNi_{1-z}Co_{z}O₂ (0<z<1)), and lithium nickel cobalt manganese composite oxides (LiₓNi_{(1-v-w)}CoᵥMn_{w}O₂ (0<v+w<1, v>0, w>0)), lithium manganese composite oxide (LiMn₂O₄) having a spinel structure, and lithium manganese nickel composite oxides (LiMn₂₋ₜNiₜO₄ (0<t<2)). Most of all, composite oxides containing cobalt are preferable. This is because a high capacity is obtained and, in addition, excellent cycle characteristics are obtained. Examples of phosphates containing lithium and a transition metal element include lithium iron phosphate (LiFePO₄) and lithium iron manganese phosphate (LiFe₁₋ᵤMnᵤPO₄ (0<u<1)).

Concrete Examples of such lithium composite oxides include lithium cobalt oxide (LiCoO₂), lithium nickel oxide (LiNiO₂), and lithium manganese oxide (LiMn₂O₄). Furthermore, a solid solution, in which a part of transition metal element is substituted with another element, may be used. Examples thereof include nickel cobalt lithium composite oxides (LiNi_{0.5}Co_{0.5}O₂, LiNi_{0.8}Co_{0.2}O₂, and the like). These lithium composite oxides can generate high voltages and have excellent energy densities.

Moreover, from the viewpoint of obtainment of higher electrode filling properties and cyclic characteristics, a composite particle, in which the surface of a center particle composed of any one of the above-described lithium-containing compounds is covered with fine particles composed of any one of the other lithium-containing compounds, may be employed.

Besides them, examples of positive electrode materials, which can occlude and release lithium, include oxides, e.g., vanadium oxide (V₂O₅), titanium dioxide (TiO₂), and manganese dioxide (MnO₂), disulfides, e.g., iron disulfide (FeS₂), titanium disulfide (TiS₂), and molybdenum disulfide (MoS₂), chalcogenides not containing lithium (in particular, layer compounds and spinel compounds), e.g., niobium diselenide (NbSe₂), lithium-containing compounds containing lithium, and electrically conductive polymers, e.g., sulfur, polyanilines, polythiophenes, polyacetylenes, and polypyrroles. As a matter of course, the positive electrode materials, which can occlude and release lithium, may be other than those described above. At least two types of the above-described series of positive electrode materials may be mixed in any combination.

As for the electrically conductive agent, for example, carbon materials, e.g., carbon black and graphite, are used. As for the binder, for example, at least one type selected from the group consisting of resin materials, e.g., polyvinylidene fluoride (PVdF), polytetrafluoroethylene (PTFE), polyacrylonitrile (PAN), styrene butadiene rubber (SBR), and carboxymethyl cellulose (CMC), and copolymers mainly containing these resin materials is used.

The positive electrode 41 includes a positive electrode lead 45 connected to one end portion of the positive electrode collector 41A through spot welding or ultrasonic welding. It is desirable that this positive electrode lead 45 is metal foil or in the shape of mesh. The positive electrode lead 45 not formed from a metal has no problem insofar as electrochemical and chemical stability is ensured and electrical continuity is ensured. Examples of materials for the positive electrode lead 45 include aluminum (Al) and nickel (Ni).

### Negative Electrode

The negative electrode 42 is produced by forming negative electrode active material layers 42B containing a negative electrode active material on both surfaces of a negative electrode collector 42A, and is formed having a band-shape.

The negative electrode collector 42A is formed from metal foil, e.g., copper (Cu) foil and nickel (Ni) foil. In the nonaqueous electrolyte battery 30 according to the second embodiment, the compressed pattern portion 1a explained in the first embodiment is disposed on the above-described metal foil in the same manner as that of the collector 10 according to the first embodiment, so that the negative electrode collector 42A is prepared. In the case where the compressed pattern portion 1a is disposed on one surface of the negative electrode collector 42A, the surface provided with the compressed pattern portion 1a may be either a surface facing the inside of the rolling of the rolled electrode assembly 40 or a surface facing the outside of the rolling.

The compressed pattern portion 1a disposed on the negative electrode collector 42A is specified to be in a shape formed continuously or intermittently in the longitudinal direction of the negative electrode collector 42A or a geometric shape which has anisotropy and which is formed dispersedly on the negative electrode collector 42A while the longitudinal direction of the geometric shape is nearly parallel to the longitudinal direction of the negative electrode collector 42A.

A negative electrode active material layer 42B is configured to contain at least one type of negative electrode material, which can occlude and release lithium, as the negative electrode active material and, if necessary, may be configured to contain other materials, e.g., a binder and an electrically conductive agent, which are the same as those in the positive electrode active material layer 41B. At this time, it is preferable that the chargeable capacity of the negative electrode material, which can occlude and release lithium, is larger than the discharge capacity of the positive electrode.

As for the negative electrode material, which can occlude and release lithium, for example, a carbon material is mentioned. Examples of the carbon materials include easy-to-graphitize carbon, hard-to-graphitize carbon having a lattice distance of (002) face of 0.37 nm or more, and graphite having a lattice distance of (002) face of 0.34 nm or less. More concrete examples include pyrolytic carbon, coke, glassy carbon fibers, organic polymer compound fired products, activated carbon, and carbon black. Among them, the coke include pitch coke, needle coke, petroleum coke, and the like. The organic polymer compound fired products refer to products produced by firing phenol resins, furan resins, and the like at appropriate temperatures so as to carbonize. These carbon materials are preferable because changes in crystal structure along with occlusion and release of lithium are very small extent, high energy densities are obtained, excellent cycle characteristics are obtained and, in addition, a function as an electrically conductive agent is exerted. The shape of the carbon material may be any one of the shapes of fiber, sphere, particle, and scale.

Besides the above-described carbon materials, examples of negative electrode materials, which can occlude and release lithium, include materials which can occlude and release lithium and which contain at least one type of metal elements and half metal elements as a constituent element. This is because a high energy density can be obtained. Such negative electrode materials may be simple substances, alloys, or compounds of metal elements or half metal elements or be materials having a phase of at least one type of them as at least a part of the material. In this regard, in the present disclosure, the “alloys” may include alloys containing at least one type of metal element and at least one type of half metal element, besides alloys composed of at least two types of metal elements. Furthermore, the “alloys” may include nonmetal elements. Examples of structures thereof include a solid solution, an eutectic (eutectic mixture), an intermetallic compound, and a structure in which at least two types thereof coexist.

In the case where metal based materials, such as, simple substances, alloys, or compounds of metal elements or half metal elements are mainly used as the negative electrode materials, expansion and shrinkage of the negative electrode active material layer 42B along with charge and discharge of the nonaqueous electrolyte battery 30 increases as compared with the case where carbon materials are used mainly. Consequently, it is more preferable that the collector 10 having improved yield strength, according to an embodiment of the present disclosure, is used as the negative electrode collector 42A. Furthermore, in the rolled electrode assembly 40, the negative electrode 42 and the positive electrode 41 are press-contacted and, therefore, the positive electrode 41 is influenced by expansion and shrinkage of the negative electrode active material layer 42B in the same manner as that of the negative electrode 42. Consequently, in the case where the above-described metal based material is used as the negative electrode material, it is preferable that the collector 10 according to an embodiment of the present disclosure is also used for the positive electrode collector 41A in the same manner as that of the negative electrode collector 42A.

As for the above-described metal elements or half metal elements, for example, metal elements or half metal elements, which can form alloys with lithium, are mentioned. Concrete examples include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). They may be crystalline or amorphous.

Among them, it is preferable that the negative electrode material contains group 4B metal elements or half metal elements in the short form periodic table as constituent elements. It is more preferable that at least one of silicon (Si) and tin (Sn) is contained as a constituent element, and it is particularly preferable that at least silicon is contained. This is because silicon (Si) and tin (Sn) have a large capability of occluding and releasing lithium and, therefore, high energy densities can be obtained. Examples of negative electrode materials containing at least one type of silicon and tin include a simple substance, alloys, and compounds of silicon, a simple substance, alloys, and compounds of tin, and materials having a phase of at least one type of them as at least a part of the material.

Examples of silicon alloys include alloys containing at least one type selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituent elements other than silicon. Examples of tin alloys include alloys containing at least one type selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituent elements other than tin (Sn).

Examples of tin compounds and silicon compounds include compounds containing oxygen (O) or carbon (C), and the above-described second constituent elements may be contained in addition to tin (Sn) or silicon (Si).

In particular, as for the negative electrode material containing at least one type of silicon (Si) and tin (Sn), for example, a material containing tin (Sn) as a first constituent element and, in addition to the tin (Sn), a second constituent element and a third constituent element is preferable. As a matter of course, this negative electrode material may be used together with the above-described negative electrode material. The second constituent element is at least one type selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon (Si). The third constituent element is at least one type selected from the group consisting of boron (B), carbon (C), aluminum (Al), and phosphorus (P). This is because the cycle characteristics are improved by containing the second element and the third element.

Most of all, a SnCoC-containing material, in which tin (Sn), cobalt (Co), and carbon (C) are contained as constituent elements, the content of carbon (C) is within the range of 9.9 percent by mass or more and 29.7 percent by mass or less, and the proportion (Co/(Sn+Co)) of cobalt (Co) relative to the total of tin (Sn) and cobalt (Co) is within the range of 30 percent by mass or more and 70 percent by mass or less, is preferable. This is because a high energy density is obtained and excellent cycle characteristics are obtained in such a composition range.

This SnCoC-containing material may further contain other constituent elements, as necessary. As for the other constituent elements, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), or bismuth (Bi) is preferable, and at least two types thereof may be contained. This is because the capacity characteristics and the cycle characteristics are further improved.

It is preferable that the SnCoC-containing material has a phase containing tin (Sn), cobalt (Co), and carbon (C), and this phase has a low-crystalline or amorphous structure. Furthermore, it is preferable that in the SnCoC-containing material, at least a part of carbon serving as a constituent element is bonded to a metal element or half metal element serving as the other constituent element. This is because coagulation or crystallization of tin (Sn) and the like is suppressed by bonding of carbon (C) to the other elements, while it is believed that reduction in cycle characteristics is caused by the coagulation or crystallization.

Examples of negative electrode materials, which can occlude and release lithium, also include metal oxides and polymer compounds, which can occlude and release lithium. The metal oxide is for example, iron oxide, ruthenium oxide, or molybdenum oxide, and the polymer compound is, for example, a polyacetylene, a polyaniline, or a polypyrrole.

The negative electrode material, which can occlude and release lithium, may be other than those described above. At least two types of the above-described negative electrode materials may be mixed in any combination.

The negative electrode active material layer 42B may be formed by any one of, for example, a vapor phase method, a liquid phase method, a thermal spraying method, a firing method, and coating. At least two of them may be combined. In the case where the negative electrode active material layer 42B is formed by a vapor phase method, a liquid phase method, a thermal spraying method, a firing method, or at least two types of those methods, it is preferable that the negative electrode active material layer 42B and the negative electrode collector 42A are alloyed at at least a part of the interface. Concretely, it is preferable that at the interface, the constituent elements of the negative electrode collector 42A are diffused into the negative electrode active material layer 42B, the constituent elements of the negative electrode active material layer 42B are diffused into the negative electrode collector 42A, or the constituent elements of them are mutually diffused. This is because breakage due to expansion and shrinkage of the negative electrode active material layer 42B along with charge and discharge may be suppressed and, in addition, the electron conductivity between the negative electrode active material layer 42B and the negative electrode collector 42A may be improved.

Examples of the vapor phase methods include a physical deposition method and a chemical deposition method, concretely, a vacuum evaporation method, a sputtering method, an ion plating method, a laser abrasion method, a chemical vapor deposition (CVD) method, and a plasma chemical vapor deposition method. As for the liquid phase method, techniques in related art, e.g., electroplating or electroless plating, may be used. The firing method refers to a method in which, for example, a particulate negative electrode active material is applied by mixing with a binder and the like so as to be dispersed into a solvent and, thereafter, a heat treatment is performed at a temperature higher than the melting point of the binder and the like. As for the firing method, techniques in related art may be used, and examples thereof include an atmosphere firing method, a reaction firing method, and a hot press firing method.

The negative electrode 42 includes a negative electrode lead 46 connected to one end portion of the negative electrode collector 42A through spot welding or ultrasonic welding. It is desirable that this negative electrode lead 46 is metal foil or in the shape of mesh. The negative electrode lead 46 not formed from a metal has no problem insofar as electrochemical and chemical stability is ensured and electrical continuity is ensured. Examples of materials for the negative electrode lead 46 include copper (Cu) and nickel (Ni).

### Separator

The separator 43 isolates the positive electrode 41 and the negative electrode 42, so as to pass lithium ions while preventing a short circuit in a current due to contact between the two electrodes. The separator 43 is impregnated with, for example, a nonaqueous electrolytic solution which is a liquid nonaqueous electrolyte. This nonaqueous electrolytic solution contains a nonaqueous solvent and an electrolyte salt dissolved in this nonaqueous solvent.

This separator 43 is formed from a synthetic resin porous film made from, for example, polyethylene (PE), polypropylene (PP), or polytetrafluoroethylene (PTFE) or a ceramic porous film. A structure in which at least two types of porous films are stacked may be employed.

The separator 43 may be a porous film formed by mixing several types of resin materials among polyethylene (PE), polypropylene (PP), polytetrafluoroethylene (PTFE), and the like. Furthermore, a surface layer, in which ceramic particles of alumina (Al₂O₃), silica (SiO₂), or the like are mixed into polyvinylidene fluoride (PVdF), may be formed on the surface of a porous film of polyethylene (PE), polypropylene (PP), polytetrafluoroethylene (PTFE), or the like. The above-described porous film made from polyolefin based resin material is preferable because an excellent short-circuit preventing effect is exerted and, in addition, the safety of a battery may be improved through a shutdown effect.

### Nonaqueous Electrolytic Solution

The nonaqueous electrolytic solution contains an electrolyte salt and a nonaqueous solvent to dissolve this electrolyte salt.

The electrolyte salt contains, for example, at least one type of light-metal compounds, e.g., lithium salts. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). Among them, at least one type selected from the group consisting of lithium hexafluorophosphate, lithium tetrafluoroborate, lithium perchlorate, and lithium hexafluoroarsenate, and lithium hexafluorophosphate is more preferable.

Examples of nonaqueous solvent include lactone based solvents, e.g., γ-butyrolactone, γ-valerolactone, δ-valerolactone, and ε-caprolactone, carbonic acid ester based solvents, e.g., ethylene carbonate, propylene carbonate, butylene carbonate, vinylene carbonate, dimethyl carbonate, ethyl methyl carbonate, and diethyl carbonate, ether based solvents, e.g., 1,2-dimethoxyethane, 1-ethoxy-2-methoxyethane, 1,2-diethoxyethane, tetrahydrofuran, and 2-methyltetrahydrofuran, nitrile based solvents, e.g., acetonitrile, sulfolane based solvents, and nonaqueous solvents, e.g., phosphoric acids, phosphoric acid ester solvents, and pyrrolidones. The solvents may be used alone, or at least two types may be used in combination.

It is preferable that a cyclic carbonic acid ester and a chain carbonic acid ester are mixed and used as the nonaqueous solvent, and it is more preferable that a compound, in which a part of or all of hydrogen in the cyclic carbonic acid ester and the chain carbonic acid ester are fluorinated, is contained. As for the fluorinated compound, it is preferable that fluoroethylene carbonate (4-fluoro-1,3-dioxolan-2-on: FEC) and difluoroethylene carbonate (4,5-difluoro-1,3-dioxolan-2-on: DFEC) are used. This is because even in the case where a negative electrode 42 containing a compound of silicon (Si), tin (Sn), germanium (Ge), or the like serving as a negative electrode active material is used, the charge and discharge cycle characteristics may be improved and in particular, difluoroethylene carbonate exerts an excellent effect of improving the cycle characteristics.

### (2-2) Method for Manufacturing Nonaqueous Electrolyte Battery

This nonaqueous electrolyte battery 30 may be produced as described below, for example. Regarding the method for manufacturing the positive electrode collector 41A and the negative electrode collector 42A used for the positive electrode 41 and the negative electrode 42, formation may be performed by a process including the same pressing as that for the collector 10 explained in the first embodiment.

### Method for Manufacturing Positive Electrode

The positive electrode active material, the binder, and the electrically conductive agent are mixed, so as to prepare a positive electrode mix. The resulting positive electrode mix is dispersed into a solvent, e.g., N-methyl-2-pyrrolidone, so as to prepare a mixed solution. The resulting positive electrode mix slurry is applied to the positive electrode collector 41A, followed by drying. Thereafter, the positive electrode active material layer 41B is formed through compression molding by a roll press machine or the like, so that the positive electrode 41 is obtained.

It is preferable that the formation of the positive electrode active material layer 41B is performed successively to the formation of the compressed pattern portion 1a of the positive electrode collector 41A.

### Method for Manufacturing Negative Electrode

The negative electrode active material and the binder are mixed, so as to prepare a negative electrode mix. The resulting negative electrode mix is dispersed into a solvent, e.g., N-methyl-2-pyrrolidone, so as to prepare a negative electrode mix slurry. The resulting negative electrode mix slurry is applied to the negative electrode collector 42A, followed by drying. Thereafter, the negative electrode active material layer 42B is formed through compression molding by a roll press machine or the like, so that the negative electrode 42 is obtained.

In the case where a metal based or alloy based negative electrode is used, a vapor phase method, a liquid phase method, a thermal spraying method, a firing method, or the like may be used. In the case where at least two types of those methods are used, it is preferable that the negative electrode active material layer 42B and the negative electrode collector 42A are alloyed at at least a part of the interface. Concretely, it is preferable that at the interface, the constituent elements of the negative electrode collector 42A are diffused into the negative electrode active material layer 42B, the constituent elements of the negative electrode active material layer 42B are diffused into the negative electrode collector 42A, or the constituent elements of them are mutually diffused. This is because breakage due to expansion and shrinkage of the negative electrode active material layer 42B along with charge and discharge may be suppressed and, in addition, the electron conductivity between the negative electrode active material layer 42B and the negative electrode collector 42A may be improved.

Examples of the vapor phase methods include a physical deposition method and a chemical deposition method, concretely, a vacuum evaporation method, a sputtering method, an ion plating method, a laser abrasion method, a chemical vapor deposition (CVD) method, and a plasma chemical vapor deposition method. As for the liquid phase method, techniques in related art, e.g., electroplating or electroless plating, may be used. The firing method refers to a method in which, for example, a particulate negative electrode active material is applied by mixing with a binder and the like so as to be dispersed into a solvent and, thereafter, a heat treatment is performed at a temperature higher than the melting point of the binder and the like. As for the firing method, techniques in related art may be used, and examples thereof include an atmosphere firing method, a reaction firing method, and a hot press firing method.

It is preferable that the formation of the negative electrode active material layer 42B is performed successively to the formation of the compressed pattern portion 1a of the negative electrode collector 42A.

### Production of Center Pin

A thin tabular center pin material is prepared. This center pin material is cut into a desired size through, for example, press working. Subsequently, the center pin material is formed into the shape of a tube through rolling up, and both ends are tapered to be provided with taper portions, so that a center pin 44 is formed.

### Assembly of Nonaqueous Electrolyte Battery

The positive electrode 41 and the negative electrode 42 are stacked with the separator 43 therebetween, followed by rolling, so that the rolled electrode assembly 40 is produced. The center pin 44 is inserted into the center of the rolled electrode assembly 40. The resulting rolled electrode assembly 40 is sandwiched between a pair of insulating plates 32a and 32b, the negative electrode lead 46 is welded to the can bottom portion of the battery can 31 and, in addition, the positive electrode lead 45 is welded to the protrusion portion 34a of the safety valve 34. The rolled electrode assembly 40 is held into the inside of the battery can 31, the nonaqueous electrolytic solution is injected into the inside of the battery can 31, so as to be impregnated into the separator 43. Finally, the battery lid 33, the safety valve mechanism, e.g., the safety valve 34, and the positive temperature coefficient element 37 are fixed to the open end portion of the battery can 31 by swaging with the gasket 38 therebetween. In this manner, the nonaqueous electrolyte battery 30 according to an embodiment of the present disclosure, as shown in FIG. 11, is completed.

Regarding this nonaqueous electrolyte battery 30, when charging is performed, for example, lithium ions are released from the positive electrode 41 and are occluded into the negative electrode 42 through the nonaqueous electrolytic solution impregnated into the separator 43. When discharging is performed, for example, lithium ions are released from the negative electrode 42 and are occluded into the positive electrode 41 through the nonaqueous electrolytic solution impregnated into the separator 43.

In the second embodiment, the example in which the compressed pattern portion 1a is formed on both the positive electrode collector 41A and the negative electrode collector 42A is explained. However, the compressed pattern portion 1a may be formed on at least one of the positive electrode collector 41A and the negative electrode collector 42A.

### Advantages

According to the second embodiment, breakage of the positive electrode collector 41A and the negative electrode collector 42A may be suppressed, and degradation in battery characteristics and stopping of the battery performance of the nonaqueous electrolyte battery 30 may be suppressed.

### 3. Third Embodiment

In a third embodiment, an example of a nonaqueous electrolyte battery provided with a layer-built electrode assembly will be described.

### (3-1) Whole Configuration of Nonaqueous Electrolyte Battery

### Structure of Nonaqueous Electrolyte Battery

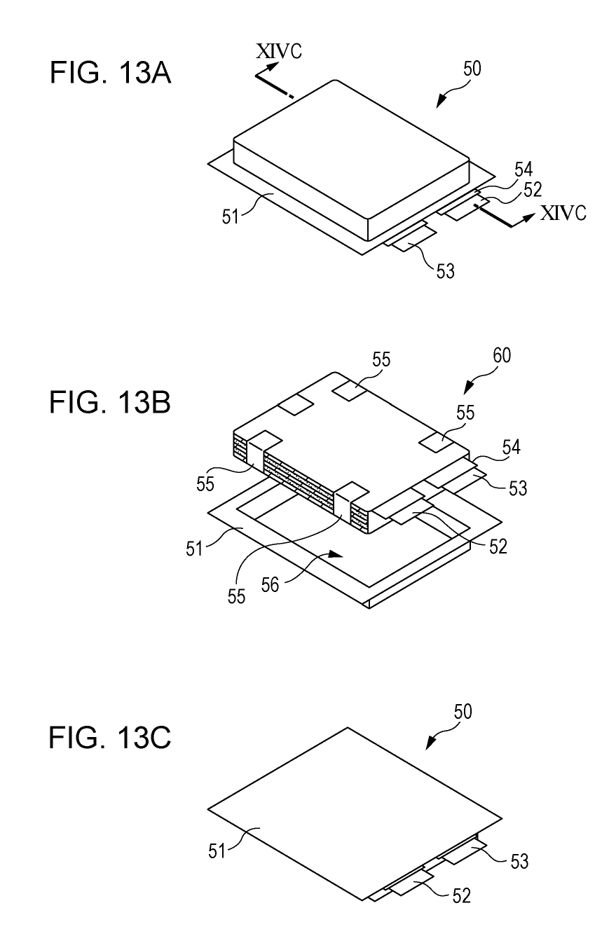

FIGS. 13A to 13C are perspective views and a perspective exploded view showing a configuration example of a nonaqueous electrolyte battery 50 according to the third embodiment. FIG. 13A is a perspective view showing an outward appearance of the nonaqueous electrolyte battery 50. FIG. 13B is a perspective exploded view showing the configuration of the nonaqueous electrolyte battery 50. FIG. 13C is a perspective view showing the configuration of the bottom surface of the nonaqueous electrolyte battery 50 shown in FIG. 13A. In the following explanation, regarding the nonaqueous electrolyte battery 50, the portion, to which the positive electrode lead 52 and the negative electrode lead 53 are led, is referred to as a top portion, the rear portion opposite to the top portion is referred to as a bottom portion, and both sides sandwiched between the top portion and the bottom portion are referred to as side portions.

Regarding the outer covering of the nonaqueous electrolyte battery 50 according to the third embodiment, a layer-built electrode assembly 60 serving as a battery element is held in a layer-built electrode assembly holding portion 56 of an outer case member 51 formed from a laminate film, and the positive electrode lead 52 and the negative electrode lead 53 electrically connected to the layer-built electrode assembly 60 are led to the outside of the battery from the portion at which the outer case members 51 are sealed with each other. The positive electrode lead 52 and the negative electrode lead 53 are led to the outside from the same side, although they may be led from the sides opposite to each other.

### Layer-Built Electrode Assembly

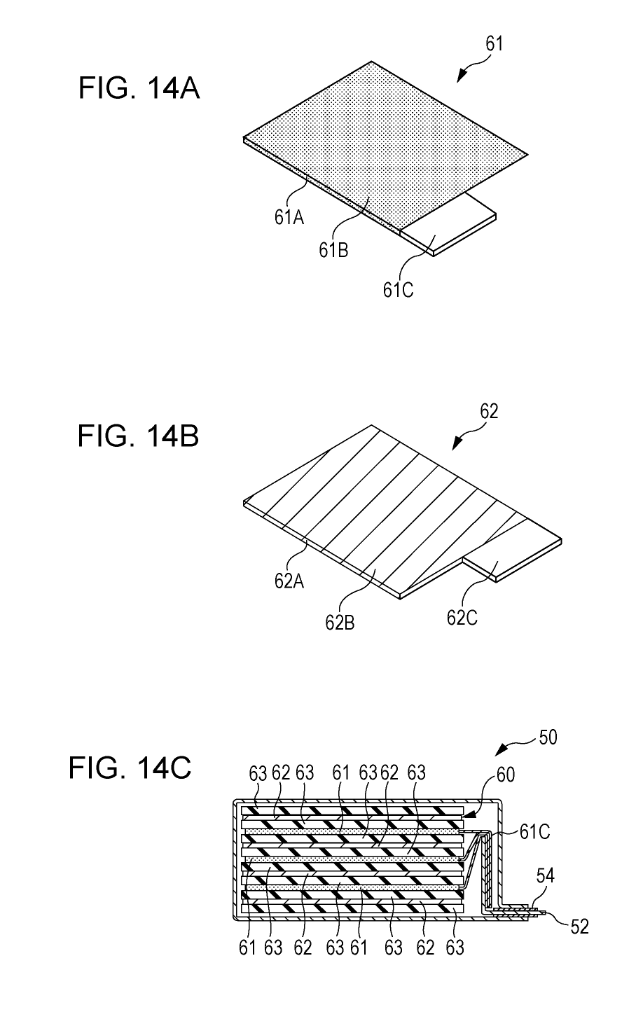

The layer-built electrode assembly 60 is formed from a rectangular positive electrode 61 shown in FIG. 14A and a rectangular negative electrode 62 shown in FIG. 14B. As shown in FIG. 14C, the layer-built electrode assembly 60 has a layer-built electrode structure in which the positive electrodes 61 and the negative electrodes 62 are stacked alternately with separators 63 therebetween. FIG. 14C is a sectional view of a section taken along a line XIVC-XIVC shown in FIG. 13A.

In the third embodiment, as shown in FIG. 14C, the layer-built electrode assembly 60, in which the separator 63, the negative electrode 62, the separator 63, the positive electrode 61, the separator 63, the negative electrode 62, . . . the separator 63, the negative electrode 62, the separator 63 are stacked sequentially in such a way that the separators 63 become the outermost surface layers of the layer-built electrode assembly 60, is used as an example of the layer-built electrode structure. In this regard, the outermost surface layer of the layer-built electrode assembly 60 is not limited to the separator 63, and the positive electrode 61 or the negative electrode 62 may become the outermost surface layer.

A positive electrode tub 61C extended from each of the plurality of positive electrodes 61 and a negative electrode tub 62C extended from each of the plurality of negative electrodes 62 are led from the layer-built electrode assembly 60. The plurality of positive electrode tubs 61C are stacked and bent in such a way that the cross-section takes on nearly the shape of the letter U while the bent portion has an appropriate slack. The positive electrode lead 52 is connected to the end portion of the stacked plurality of positive electrode tubs 61C by a method of ultrasonic welding, resistance welding, or the like.

Although not shown in the drawing, the plurality of negative electrode tubs 62C are stacked and bent in such a way that the cross-section takes on nearly the shape of the letter U while the bent portion has an appropriate slack in the same manner as that in the positive electrode 61. The negative electrode lead 53 is connected to the end portion of the stacked plurality of negative electrode tubs 62C by a method of ultrasonic welding, resistance welding, or the like.

The individual portions constituting the layer-built electrode assembly 60 will be described below.

### Positive Electrode

As shown in FIG. 14A, the positive electrode 61 includes a positive electrode collector 61A provided with a rectangular principal surface portion and an extension portion extended from the principal surface portion. A positive electrode active material layer 61B is disposed on the rectangular principal surface of the positive electrode collector 61A. In the positive electrode collector 61A, the extension portion not provided with the positive electrode active material layer 61B has a function as the positive electrode tub 61C serving as a connection tub to be connected to the positive electrode lead 52. As for the positive electrode collector 61A, metal foil, e.g., aluminum (Al) foil, nickel (Ni) foil, or stainless steel (SUS) foil, may be used, in the same manner as that in the second embodiment.

In the nonaqueous electrolyte battery 50 according to the third embodiment, regarding the principal surface portion of the positive electrode collector 61A, the compressed pattern portion 1a explained in the first embodiment is disposed on the above-described metal foil in the same manner as that of the collector 10 according to the first embodiment. The compressed pattern portion 1a disposed on the positive electrode collector 61A is specified to have, for example, a geometric shape which is disposed on the principal surface portion of the positive electrode collector 61A dispersedly and which does not have anisotropy.

As for the positive electrode active material, the electrically conductive agent, and the binder constituting the positive electrode active material layer 61B, the same materials as those for the positive electrode 41 in the second embodiment may be used.

### Negative Electrode

As shown in FIG. 14B, the negative electrode 62 includes a negative electrode collector 62A provided with a rectangular principal surface portion and an extension portion extended from the principal surface portion. A negative electrode active material layer 62B is disposed on the rectangular principal surface portion of the negative electrode collector 62A. In the negative electrode collector 62A, the extension portion not provided with the negative electrode active material layer 62B has a function as the negative electrode tub 62C serving as a connection tub to be connected to the negative electrode lead 53. As for the negative electrode collector 62A, metal foil, e.g., copper (Cu) foil and nickel (Ni) foil, may be used, in the same manner as that in the second embodiment.

In the nonaqueous electrolyte battery 50 according to the third embodiment, regarding the principal surface portion of the negative electrode collector 62A, the compressed pattern portion 1a explained in the first embodiment is disposed on the above-described metal foil in the same manner as that of the collector 10 according to the first embodiment. The compressed pattern portion 1a disposed on the negative electrode collector 62A is specified to have, for example, a geometric shape which is disposed on the principal surface portion of the negative electrode collector 62A dispersedly and which does not have anisotropy.

As for the negative electrode active material, the electrically conductive agent, and the binder constituting the negative electrode active material layer 62B, the same materials as those for the negative electrode 42 in the second embodiment may be used.

### Positive Electrode Lead

As for the positive electrode lead 52 connected to a plurality of positive electrode tubs 61C, a metal lead body formed from, for example, aluminum (Al) may be used. A sealant 54, which is an adherence film to improve adherence between the outer case member 51 and the positive electrode lead 52, is disposed on a part of the positive electrode lead 52 opposite to the outer case member 51. The sealant 54 is formed from a resin material exhibiting high adhesion to a metal material. For example, in the case where the positive electrode lead 52 is formed from the above-described metal material, it is preferable that the sealant 54 is formed from a polyolefin resin, e.g., polyethylene (PE), polypropylene (PP), modified polyethylene, or modified polypropylene.

The thickness of the sealant 54 is preferably 50 μm or more and 130 μm or less. If the thickness is less than 50 μm, the adhesion between the positive electrode lead 52 and the outer case member 51 is poor, and the thickness more than 130 μm is not preferable from the viewpoint of a production process because the amount of flow of a molten resin during heat fusion is large.

### Negative Electrode Lead

As for the negative electrode lead 53 connected to a plurality of negative electrode tubs 62C, a metal lead body formed from, for example, nickel (Ni) may be used. A sealant 54, which is an adherence film to improve adherence between the outer case member 51 and the negative electrode lead 53, is disposed on a part of the negative electrode lead 53 opposite to the outer case member 51 in the same manner as that of the positive electrode lead 52.

### Separator

As for the separator 63, the same porous film as that for the separator 43 according to the second embodiment may be used. Regarding the nonaqueous electrolyte battery 50 covered with the outer case member 51 formed from a laminate film, as in the third embodiment, in order to prevent leakage of the nonaqueous electrolytic solution, a gel electrolyte may be formed by gelling the nonaqueous electrolytic solution. In order to form such a gel electrolyte, the separator 63, in which a polymer material containing vinylidene fluoride (PVdF) is attached on the surface in advance, may be used. In the case where the separator 63, in which a polymer material containing vinylidene fluoride is attached on the surface in advance, is used, the polymer material containing vinylidene fluoride is reacted with the nonaqueous electrolytic solution thereafter, so as to hold the nonaqueous electrolytic solution and form a gel electrolyte.

### Nonaqueous Electrolyte

Regarding the nonaqueous electrolyte battery 50 according to the third embodiment, a nonaqueous electrolytic solution in which an electrolyte salt is dissolved into a nonaqueous solvent, may be used, as in the second embodiment. The nonaqueous electrolytic solution is sealed into the outer case member 51 together with the layer-built electrode assembly 60.

Alternatively, a gel electrolyte layer may be formed without using the separator 63, in which a polymer material containing vinylidene fluoride is attached on the surface, in contrast to the above description. In this case, a sol solution formed by taking the nonaqueous electrolytic solution in the polymer is applied to both surfaces of each of the positive electrode 61 and the negative electrode 62 or both surfaces of the separator 63, followed by drying. In this manner, the gel electrolyte layer, in which the nonaqueous electrolytic solution is taken in the polymer material, may be formed.

### Laminate Film

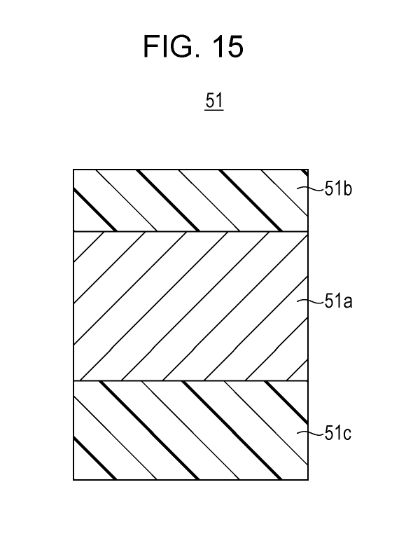

As shown in FIG. 15, the outer case member 51 is a laminate film having a structure in which, for example, an inner resin layer 51c, a metal layer 51a, and an outer resin layer 51b are stacked in that order from the side opposite to the layer-built electrode assembly 60 and are bonded. Adherence layers having a thickness of, for example, about 2 μm or more and 3 μm or less may be disposed between the outer resin layer 51b and the metal layer 51a and between the inner resin layer 51c and the metal layer 51a. Each of the outer resin layer 51b and the inner resin layer 51c may be formed from a plurality of layers. In the case where the nonaqueous electrolyte battery 50 is further held in a harder outer case or the like, the outer case member 51 may be a resin film not including the metal layer 51a.

The metal material constituting the metal layer 51a is provided with a function as a barrier film having moisture transmission resistance and aluminum (Al) foil, stainless steel (SUS) foil, nickel (Ni) foil, iron (Fe) foil subjected to plating, and the like may be used. Among them, it is favorable that aluminum foil, which is thin, light-weight, and excellent in workability, is used. In particular, from the viewpoint of workability, for example, mild aluminum (Al) subjected to an annealing treatment is preferable. For example, it is preferable that A8021P-O, A8079P-O, A1N30-O, and the like on the basis of JIS are used.

The thickness of the metal layer 51a may be set arbitrarily insofar as the strength suitable for the battery outer case member is obtained. However, 30 μm or more and 50 μm or less is preferable. This range may ensure sufficient material strength and, in addition, high workability. Furthermore, a reduction in volumetric efficiency of the nonaqueous electrolyte battery 50 due to an increase in thickness of the outer case member 51 may be suppressed.

The inner resin layer 51c is a portion which is melted by heat, so as to be fused mutually, and polyethylene (PE), cast polypropylene (CPP), polyethylene terephthalate (PET), low-density polyethylene (LDPE), high-density polyethylene (HDPE), linear low-density polyethylene (LLDPE), and the like may be used. A plurality of types may be selected from them and be used.

The thickness of the inner resin layer 51c is specified to be preferably 20 μm or more and 50 μm or less. This range may suppress an occurrence of short circuit because the sealing property of the outer case member 51 is enhanced and a pressure buffer action in sealing is obtained sufficiently. The thickness of the inner resin layer 51c serving as an infiltration path of moisture from the outside of the battery is not increased unnecessarily and, thereby, generation of a gas in the inside of the battery, expansion of the battery along with that, and degradation in battery characteristics may be suppressed. The thickness of the inner resin layer 51c is a thickness in the state before the outer covering is mounted on the layer-built electrode assembly 60. After the outer case member 51 is mounted on the layer-built electrode assembly 60 and sealing is performed, two layers of inner resin layer 51c are fused mutually, so that the thickness of the inner resin layer 51c may become out of the above-described range.

As for the outer resin layer 51b, polyolefin based resins, polyamide based resins, polyimide based resins, polyesters, and the like are used from the viewpoint of beauty of the appearance, toughness, flexibility, and the like. Concretely, nylon (Ny), polyethylene terephthalate (PET), polyethylene naphthalate (PEN), polybutylene terephthalate (PBT), and polybutylene naphthalate (PBN) are used. A plurality of types may be selected from them and be used.

Layers of the inner resin layer 51c are melted through heat fusion and the outer case member 51 is bonded. Therefore, it is preferable that the outer resin layer 51b has a melting point higher than the melting point of the inner resin layer 51c. This is because only the inner resin layer 51c is melted in the heat fusion. Consequently, the material usable for the outer resin layer 51b may be selected on the basis of the resin material selected for the inner resin layer 51c.

The thickness of the outer resin layer 51b is specified to be preferably 10 μm or more and 30 μm or less. This range may ensure a function as a protective layer sufficiently. Furthermore, a reduction in volumetric efficiency of the nonaqueous electrolyte battery 50 may be suppressed because the thickness is not unnecessarily increased.

### (3-2) Method for Manufacturing Nonaqueous Electrolyte Battery

This nonaqueous electrolyte battery 50 may be produced as described below, for example. Regarding the method for manufacturing the positive electrode collector 61A and the negative electrode collector 62A used for the positive electrode 61 and the negative electrode 62, formation may be performed by a process including the same pressing as that for the collector 10 explained in the first embodiment.

### Production of Positive Electrode

A positive electrode mix slurry is prepared in the same manner as that in the second embodiment. The resulting positive electrode mix slurry is applied in such a way that a positive electrode collector exposed portion is disposed at one end of both surfaces of the metal foil serving as the continuous band-shaped positive electrode collector 61A. Subsequently, the solvent in the positive electrode mix slurry is dried and, thereafter, the positive electrode active material layer 61B is formed through compression molding by a roll press machine or the like, so as to obtain a positive electrode sheet. The resulting positive electrode sheet is cut into a predetermined dimension, so as to produce the positive electrode 61. At this time, the positive electrode sheet is cut in such a way that the positive electrode collector exposed portion not provided with the positive electrode active material layer 61B becomes the positive electrode tub 61C. In this manner, the positive electrode 61 with the integrally formed positive electrode tub 61C is obtained.

### Production of Negative Electrode

A negative electrode mix slurry is prepared in the same manner as that in the second embodiment. The resulting negative electrode mix slurry is applied in such a way that a negative electrode collector exposed portion is disposed at one end of both surfaces of the metal foil serving as the continuous band-shaped negative electrode collector 62A. Subsequently, the solvent in the negative electrode mix slurry is dried and, thereafter, the negative electrode active material layer 62B is formed through compression molding by a roll press machine or the like, so as to obtain a negative electrode sheet. The resulting negative electrode sheet is cut into a predetermined dimension, so as to produce the negative electrode 62. At this time, the negative electrode sheet is cut in such a way that the negative electrode collector exposed portion not provided with the negative electrode active material layer 62B becomes the negative electrode tub 62C. In this manner, the negative electrode 62 with the integrally formed negative electrode tub 62C is obtained.

### Stacking

The positive electrode 61 and the negative electrode 62 are stacked alternately with the separator 63 therebetween. The positive electrode 61, the negative electrode 62, and the separator 63 are pressed to come into intimate contact with one another, and are fixed by using fixing members 55, e.g., adhesive tapes, so as to produce the layer-built electrode assembly 60. In the case where fixing is performed by using the fixing member 55, for example, the fixing members 55 are disposed on both side portions of the layer-built electrode assembly 60.

The plurality of sheets of positive electrode tubs 61C and the plurality of sheets of negative electrode tubs 62C are bent respectively in such a way that the cross-section takes on the shape of the letter U. Preferably, the positive electrode tubs 61C and the negative electrode tubs 62C are bent by using the tub bending method in Japanese Unexamined Patent Application Publication No. 2009-187768.

### Outer Covering

The resulting layer-built electrode assembly 60 is covered with the outer case member 51. One of the side portions, the top portion, and the bottom portion are heated with a heater head to effect heat fusion. The top portion and the bottom portion, to which the positive electrode lead 52 and the negative electrode lead 53 are led, are heat-fused through heating with, for example, a heater head having a notch.

The nonaqueous electrolytic solution is injected from an opening of the other side portion not heat-fused. Finally, the outer case member 51 of the side portion, from which the solution is injected, is heat-fused, so that the layer-built electrode assembly 60 is sealed into the outer case member 51 and the nonaqueous electrolyte battery 50 is produced. In the case where a polymer material containing vinylidene fluoride (PVdF) adheres to the surface of the separator 63 in advance, the layer-built electrode assembly 60 is further pressured and heated from the outside of the outer case member 51, so that the nonaqueous electrolytic solution is held by the polymer material containing vinylidene fluoride. In this manner, a gel electrolyte layer is formed between the positive electrode 61 and the negative electrode 62.

### Advantages

According to the third embodiment, breakage of the positive electrode collector 61A and the negative electrode collector 62A may be suppressed, and degradation in battery characteristics and stopping of the battery performance of the nonaqueous electrolyte battery 50 may be suppressed.

### 4. Fourth Embodiment

In a fourth embodiment, a battery pack provided with a nonaqueous electrolyte battery by using the collector 10 according to the first embodiment will be described.

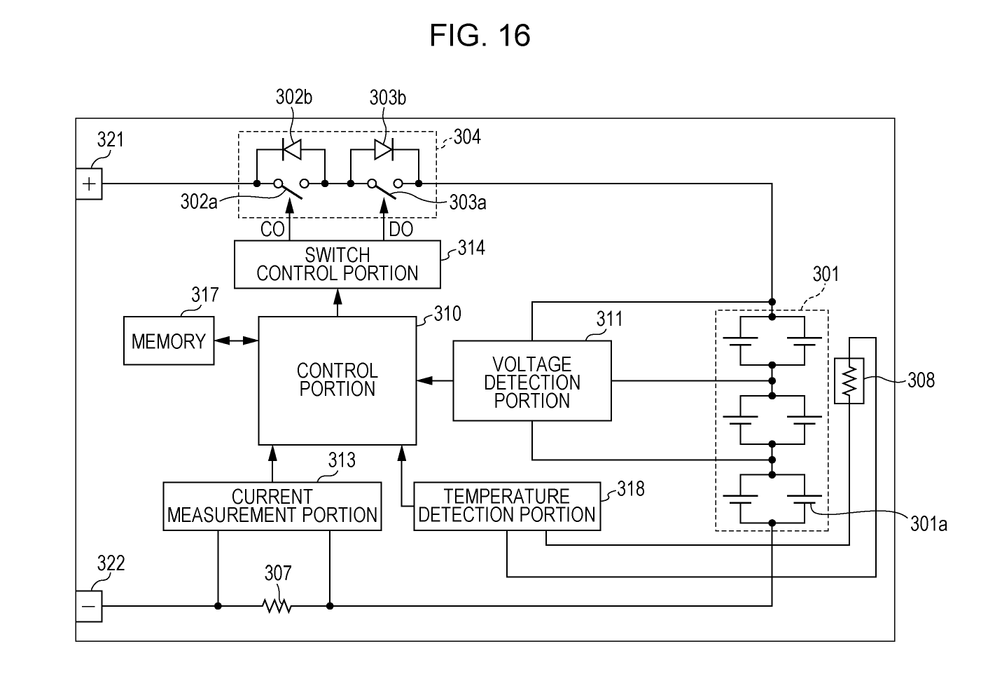

FIG. 16 is a block diagram showing a circuit configuration example in the case where the nonaqueous electrolyte battery according to an embodiment of the present disclosure is applied to a battery pack. The battery pack is provided with an assembled battery 301, an outer case, a switch portion 304 including a charge control switch 302a and a discharge control switch 303a, a current detection resistance 307, a temperature detection element 308, and a control portion 310.

The battery pack is provided with a positive electrode terminal 321 and a negative electrode terminal 322, and in charging, the positive electrode terminal 321 and the negative electrode terminal 322 are connected to a positive electrode terminal and a negative electrode terminal, respectively, of a battery charger, so that charging is performed. In the case where an electronic device is used, the positive electrode terminal 321 and the negative electrode terminal 322 are connected to a positive electrode terminal and a negative electrode terminal, respectively, of the electronic device, so that discharging is performed.

The assembled battery 301 is formed by connecting a plurality of nonaqueous electrolyte batteries 301a in series and/or in parallel. This nonaqueous electrolyte battery 301a is the nonaqueous electrolyte battery 30, the nonaqueous electrolyte battery 50, or the like according to embodiments of the present disclosure. In FIG. 16, the case where six nonaqueous electrolyte batteries 301a are connected in such a way that three sets of parallel batteries are connected in series (2P3S) is shown as an example. However, any other connection method may be employed, for example, m sets of n batteries in parallel may be connected in series (n and m represent independently an integer).

The switch portion 304 includes the charge control switch 302a, a diode 302b, the discharge control switch 303a, and a diode 303b and is controlled by the control portion 310. The diode 302b has polarity in the reverse direction with respect to a charge current passing from the positive electrode terminal 321 toward the assembled battery 301 and in the forward direction with respect to a discharge current passing from the negative electrode terminal 322 toward the assembled battery 301. The diode 303b has polarity in the forward direction with respect to the charge current and in the reverse direction with respect to the discharge current. In the example, the switch portion is disposed on the positive side, but may be disposed on the negative side.

The charge and discharge control portion controls in such a way that the charge control switch 302a is turned off when the battery voltage becomes an overcharge detection voltage and, thereby, a charge current does not pass the current path of the assembled battery 301. After the charge control switch is turned off, only discharging is possible through the diode 302b. Furthermore, the control portion 310 controls in such a way that the charge control switch 302a is turned off when a large current passes during charging and, thereby, a charge current passing the current path of the assembled battery 301 is interrupted.

The control portion 310 controls in such a way that the discharge control switch 303a is turned off when the battery voltage becomes an overdischarge detection voltage and, thereby, a discharge current does not pass the current path of the assembled battery 301. After the discharge control switch 303a is turned off, only charging is possible through the diode 303b. Furthermore, the control portion 310 controls in such a way that the discharge control switch 303a is turned off when a large current passes during discharging and, thereby, a discharge current passing the current path of the assembled battery 301 is interrupted.

The temperature detection element 308 is, for example, a thermistor, and is disposed in the vicinity of the assembled battery 301 to measure the temperature of the assembled battery 301 and send the measured temperature to the control portion 310. The voltage detection portion 311 measures voltages of the assembled battery 301 and the individual nonaqueous electrolyte batteries 301a constituting the assembled battery 301, and A/D converts the measured voltages, so as to send the results to the control portion 310. The current measurement portion 313 measures the current by using the current detection resistance 307 and sends the measured current to the control portion 310.

The switch control portion 314 controls the charge control switch 302a and the discharge control switch 303a of the switch portion 304 on the basis of the voltage and the current input from the voltage detection portion 311 and the current measurement portion 313. The switch control portion 314 prevents overcharge, overdischarge, and overcurrent charge and discharge by sending a control signal to the switch portion 304 when the voltage of any one of the nonaqueous electrolyte batteries 301a becomes less than or equal to the overcharge detection voltage or the overdischarge detection voltage or when a large current passes suddenly.

Here, for example, in the case where the nonaqueous electrolyte battery is a lithium ion secondary battery, the overcharge detection voltage is specified to be, for example, 4.20 V±0.05 V, and the overdischarge detection voltage is specified to be, for example, 2.4 V±0.1 V.

As for the charge and discharge switch, for example, semiconductor switches, e.g., MOSFET, may be used. In this case, a parasitic diode of MOSFET functions as the diodes 302b and 303b. In the case where a P-channel type FET is used as the charge and discharge switch, the switch control portion 314 sends control signals DO and CO to the gate of the charge control switch 302a and the gate of the discharge control switch 303a, respectively. In the case where the charge control switch 302a and the discharge control switch 303a are of P-channel type, the switches are turned on at the gate potential lower than the source potential by a predetermined value or more. That is, regarding usual charge and discharge operations, the control signals CO and DO are specified to be at low levels, and the charge control switch 302a and the discharge control switch 303a are specified to be in the on state.

For example, in the case of overcharge or overdischarge, the control signals CO and DO are specified to be at high levels, and the charge control switch 302a and the discharge control switch 303a are specified to be in the off state.

The memory 317 is formed from RAM or ROM, e.g., erasable programmable read only memory (EPROM), which is nonvolatile memory. Regarding the memory 317, the numerical values calculated in the control portion 310, internal resistance values of the batteries in an initial state of the individual nonaqueous electrolyte batteries 301a, which are measured at a stage in the production process, and the like are stored in advance, and it is also possible to rewrite appropriately. In the case where a full charge capacity of the nonaqueous electrolyte batteries 301a is stored, for example, the remaining capacity can be calculated together with the control portion 310.

A temperature detection portion 318 measures the temperature by using the temperature detection element 308, so as to perform charge and discharge control when abnormal heat generation occurs and perform correction in calculation of the remaining capacity.

### 5. Fifth Embodiment

In the fifth embodiment, electronic apparatuses, electric vehicles, electricity storage devices, and the like, on which the nonaqueous electrolyte batteries according to the second and the third embodiments and the battery pack according to the fourth embodiment are mounted, will be described. The nonaqueous electrolyte batteries and the battery pack explained in the second to the fourth embodiments may be used for supplying the electric power to apparatuses, e.g., electronic apparatuses, electric vehicles, electricity storage devices, and the like.

Examples of electronic apparatuses include notebook-size personal computers, personal digital assistants (PDA), cellular phones, cordless phone handsets, video movies, digital steel cameras, electronic books, electronic dictionaries, music players, radios, headphones, game machines, navigation systems, memory cards, pacemakers, hearing aids, power tools, electric shavers, refrigerators, air conditioners, televisions, stereos, water heaters, microwave ovens, dish washers, washing machines, dryers, lighting devices, toys, medical devices, robots, road conditioners, and signals.

Examples of electric vehicles include railway vehicles, golf carts, electric carts, and electric cars (including hybrid cars). Examples of uses include driving power supplies and auxiliary power supplies for them.

Examples of electricity storage devices include electricity storage power supplies for housing and other buildings and power generation facilities.

Among the above-described application examples, concrete examples of electricity storage systems by using the electricity storage device, to which the nonaqueous electrolyte battery according to an embodiment of the present disclosure is applied, will be described below.

As for this electricity storage system, for example, the following configurations are mentioned. A first electricity storage system is an electricity storage system in which an electricity storage device is charged by a generating set which generates electricity from renewable energy. A second electricity storage system is an electricity storage system which has an electricity storage device and which supplies electric power to an electronic apparatus connected to the electricity storage device. A third electricity storage system is an electronic apparatus which is supplied with an electric power from the electricity storage device. These electricity storage systems are executed as systems to supply efficiently an electric power synergistically with an external electric power supply network.

A fourth electricity storage system is an electric vehicle including a convertor to convert an electric power supplied from an electricity storage device to a driving force of the vehicle and a control device to process the information regarding the vehicle control on the basis of the information regarding the electricity storage device. A fifth electricity storage system is an electric power system which is provided with the other devices and an electric power information transmit-receive portion and which perform charge and discharge control of the above-described electricity storage device on the basis of the information received by the transmit-receive portion. A sixth electricity storage system is an electric power system to be supplied with an electric power from the above-described electricity storage device or to supply an electric power from a generating set or an electric power network to the electricity storage device. The electricity storage system will be described below.

### (5-1) Electricity Storage System in Housing as Application Example

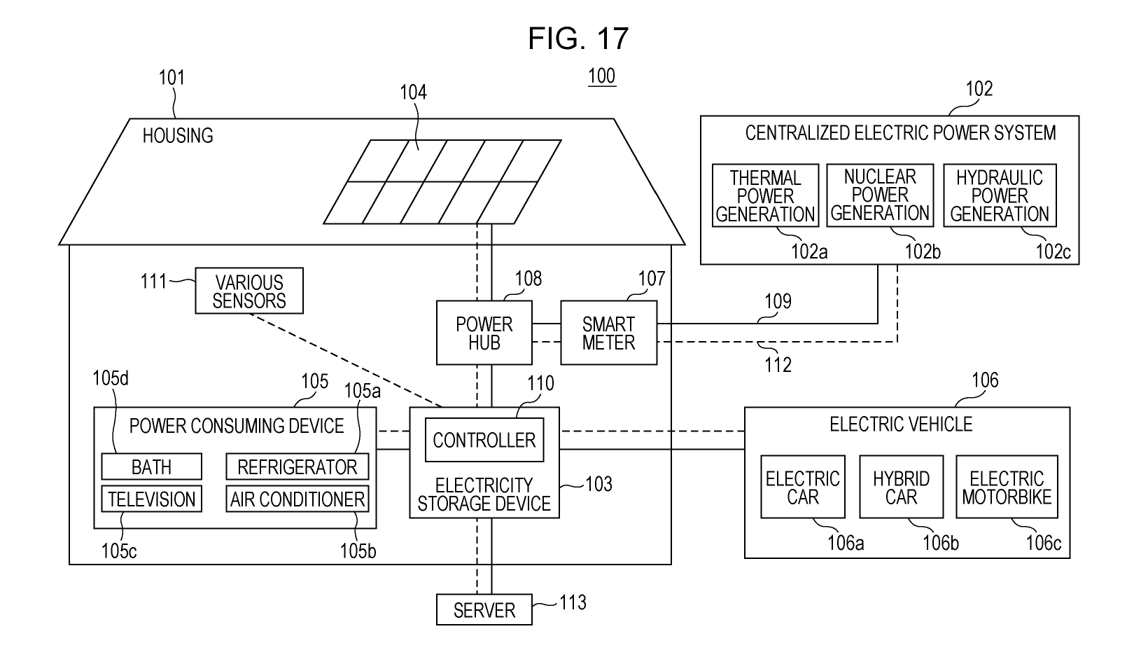

An example, in which the electricity storage device by using the nonaqueous electrolyte battery according to an embodiment of the present disclosure is applied to an electricity storage system for housing, will be described with reference to FIG. 17. For example, in an electricity storage system 100 for the housing 101, electric power is supplied from a centralized electric power system 102, e.g., thermal power generation 102a, nuclear power generation 102b, and hydraulic power generation 102c, through an electric power network 109, an information network 112, a smart meter 107, a power hub 108, and the like to an electricity storage device 103. In addition to this, an electric power is supplied from an independent power supply, e.g., a home generating set 104, to the electricity storage device 103. The electric power supplied to the electricity storage device 103 is stored. An electric power used in the housing 101 is supplied by using the electricity storage device 103. The housing 101 is not alone, but similar electricity storage systems may be used regarding buildings.

The housing 101 includes the home generating set 104, a power consuming device 105, the electricity storage device 103, a controller 110 to control the individual devices, the smart meter 107, and sensors 111 to gain various information. The individual devices are connected by the electric power network 109 and the information network 112. As for the home generating set 104, a solar cell, a fuel cell, and the like are used. The resulting electric power is supplied to the power consuming device 105 and/or the electricity storage device 103. The power consuming device 105 includes a refrigerator 105a, an air conditioner 105b, a television receiver 105c, a bath 105d, and the like. Furthermore, the power consuming device 105 includes an electric vehicle 106. The electric vehicle 106 includes an electric car 106a, a hybrid car 106b, and an electric motorbike 106c.

The nonaqueous electrolyte battery according to an embodiment of the present disclosure is applied to the electricity storage device 103. The nonaqueous electrolyte battery according to an embodiment of the present disclosure may be formed from, for example, the above-described lithium ion secondary battery. The smart meter 107 is provided with functions to measure the usage of commercial electric power, and transmit the measured usage to an electric power company. The electric power network 109 may be any one of direct current power feeding, alternating current power feeding, and noncontact power feeding or an appropriate combination of them.

Examples of various sensors 111 include motion sensors, illumination sensors, object detection sensors, power consumption sensors, vibration sensors, contact sensors, temperature sensors, and infrared sensors. The information gained by the various sensors 111 is transmitted to the control device 110. Weather conditions, human conditions, and the like are grasped on the basis of the information from the sensors 111, the power consuming device 105 is automatically controlled and, thereby, energy consumption may be minimized. The control device 110 may transmit the information regarding the housing 101 to the external electric power company and the like through the internet.

Processing of branching of the electric power line, conversion between the direct current and the alternating current, and the like are performed by the power hub 108. As for the communication system of the information network 112 connected to the control device 110, a method by using a communication interface, e.g., universal asynchronous receiver-transceiver (UART) and a method by using a sensor network on the basis of the radio communication, e.g., Bluetooth, ZigBee, and Wi-Fi, are mentioned. The Bluetooth system is applied to multimedia communications and point-to-multipoint communication can be performed. ZigBee uses the physical layer of the Institute of Electrical and Electronics Engineers (IEEE) 802.15.4. The IEEE 802.15.4 is a name of the short-range wireless network standard, which is so-called personal area network (PAN) or wireless personal area network (WPAN).

The control device 110 is connected to an external server 113. This server 113 may be controlled by any one of the housing 101, the electric power company, and a service provider. The information transmitted and received by the server 113 is the information regarding, for example, the electric power consumption information, the life pattern information, the electric power rate, the weather information, the natural disaster information, and the electric power transaction information. The information of them may be transmitted and received by the home power consuming device (for example, television receiver) or be transmitted and received by a device outside the home (for example, cellular phone). The information of them may be displayed on the devices having a display function, e.g., television receivers, cellular phones, and personal digital assistants (PDA).

The control device 110 to control the individual devices may be formed from a central processing unit (CPU), random access memory (RAM), read only memory (ROM), and the like and is held in the electricity storage device 103, in this example. The control device 110 is connected to the electricity storage device 103, the home generating set 104, the power consuming device 105, various sensors 111, and the server 113 with the information network 112 and has a function of, for example, adjusting the usage of commercial electric power and the amount of generation of electricity. In addition, a function of performing transaction of the electric power in the electric power market may be provided.

As described above, not only the electric power from the centralized electric power system 102, e.g., the thermal power 102a, the nuclear power 102b, the hydraulic power 102c, but also the electric power generated by the home generating set 104 (photovoltaic power generation, wind power generation) may be stored in the electricity storage device 103. Therefore, even when the electric power generated by the home generating set 104 is fluctuated, control may be performed in such a way that the amount of electric power fed to the outside is made constant or discharge is performed, as necessary. For example, the electric power obtained through photovoltaic power generation may be stored into the electricity storage device 103 and, in addition, a low-rate midnight power may be stored into the electricity storage device 103 at night, so as to use electric power stored in the electricity storage device 103 through discharge during daytime hours in which the electric power rate is high.

In the above-described example, the control device 110 is held in the electricity storage device 103. However, the control device 110 may be held in the smart meter 107, or be standalone. Furthermore, the electricity storage system 100 may be used for a plurality of homes in multifamily housing, or be used for a plurality of detached houses.

### (5-2) Electricity Storage System in Vehicle as Application Example

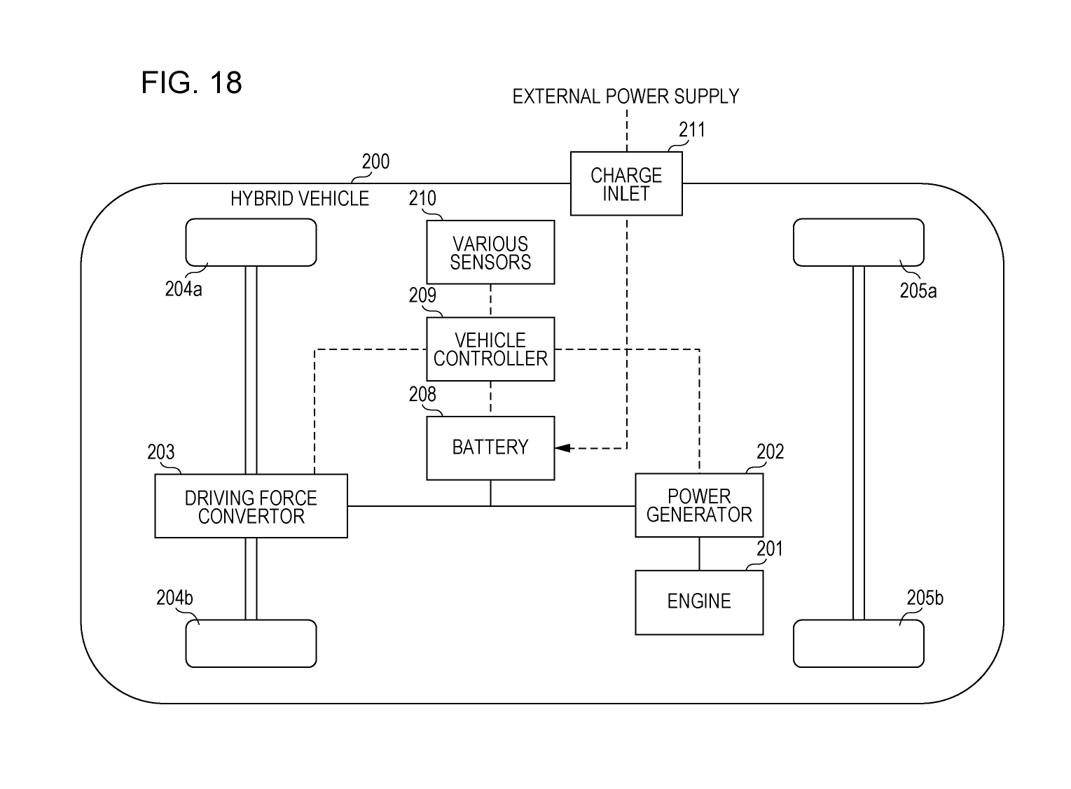

An example, in which an embodiment according to the present disclosure is applied to an electricity storage system for vehicle, will be described with reference to FIG. 18. FIG. 18 schematically shows an example of the configuration of a hybrid vehicle adopting a series hybrid system, to which an embodiment according to the present disclosure is applied. The series hybrid system is a vehicle which moves with an electric power-driving force convertor by using the electric power generated with an engine-driven generator or by storing the electric power into a battery once and using the stored electric power.

This hybrid vehicle 200 is equipped with an engine 201, a power generator 202, an electric power-driving force convertor 203, a driving wheel 204a, a driving wheel 204b, a wheel 205a, a wheel 205b, a battery 208, a vehicle controller 209, various sensors 210, and a charge inlet 211. The above-described nonaqueous electrolyte battery according to an embodiment of the present disclosure is applied to the battery 208.

The hybrid vehicle 200 moves while the electric power-driving force convertor 203 serves as a power supply. An example of the electric power-driving force convertor 203 is a motor. The electric power-driving force convertor 203 is actuated by the electric power of the battery 208, and the torque of this electric power-driving force convertor 203 is transmitted to the driving wheels 204a and 204b. The electric power-driving force convertor 203 may be applied to both an alternating current motor and a direct current motor by using direct current-alternating current (DC-AC) conversion or reverse conversion (AC-DC conversion) at a necessary place. The various sensors 210 controls the engine revolution number through the vehicle controller 209 and controls the degree of opening of a throttle valve (throttle opening), although not shown in the drawing. The various sensors 210 include a speed sensor, an acceleration sensor, an engine revolution number sensor and the like.

The torque of the engine 201 is transmitted to the power generator 202, and the electric power generated by the power generator 202 on the basis of the torque may be stored in the battery 208.

When the hybrid vehicle 200 is decelerated by a brake mechanism, although not shown in the drawing, the resistance during the deceleration is applied as a torque to the electric power-driving force convertor 203, and a regenerative electric power generated by the electric power-driving force convertor 203 on the basis of the torque is stored in the battery 208.

The battery 208 may be connected to an external power supply of the hybrid vehicle 200 and, thereby, an electric power may be supplied from the external power supply while the charge inlet 211 serves as an input port, so as to store the received electric power.

Although not shown in the drawing, an information processing device to perform information processing with respect to vehicle control on the basis of the information regarding the nonaqueous electrolyte battery may be provided. Examples of such information processing devices include an information processing device to display the remaining amount of battery on the basis of the information regarding the remaining amount of the battery.

In the above description, the series hybrid vehicle, which moves with the motor by using the electric power generated with the engine-driven generator or by storing the electric power into the battery once and using the stored electric power, is explained as an example. However, embodiments according to the present disclosure may be applied effectively to a parallel hybrid vehicle, in which both the outputs of the engine and the motor are employed as the driving sources and three systems, that is, movement with only the engine, movement with only the motor, and movement with the engine and the motor, are used through appropriate switching. Furthermore, embodiments according to the present disclosure may also be applied effectively to a so-called electric vehicle which is moved while being driven by only an electric motor without using an engine.

### EXAMPLES

The present disclosure will be described below in further detail with reference to examples. The present disclosure is not limited to the following examples.

In the following examples, a plurality of compressed pattern portions according to embodiments of the present disclosure were disposed on metal foil usable as a collector for a battery and the characteristics of the foil were examined regarding the individual cases.

### Example 1

In Example 1, regarding test metal foil in which a compressed pattern portion was disposed all over the metal foil, the characteristics were examined by a tensile test.

### Example 1-1

### Production of Emboss Roll

A straight-line shaped continuous compressed pattern portion was formed on metal foil through roll-pressing of the metal foil by using an emboss roll provided with a straight-line shaped uneven pattern. The uneven pattern on the surface of the emboss was produced by subjecting copper plating formed on the cylindrical metal roll surface to a wet etching treatment in such a way that a continuous convex portion was disposed in the circumferential direction.

Initially, a copper plating layer was formed on the metal roll surface, and mask composed of a resist film was formed on the surface of the copper plating layer. Thereafter, an exposure pattern having a width of 50 μm at a pitch of 100 μm was formed on the mask through laser drawing, so as to form the stripe-shaped exposure pattern. Then, the resulting exposure pattern was subjected to a wet etching treatment and, thereby, the exposure pattern portion was etched, so as to form a stripe structure having an uneven cross-sectional shape.

Subsequently, the whole mask portion was peeled through ashing, and the roll surface was subjected to the wet etching treatment again. Consequently, the stripe structure in which corner portions of the uneven structure were smoothened, was formed on the roll surface. Finally, a hard chromium layer having a thickness of 10 μm was formed on the metal roll surface through plating, so as to obtain the emboss roll.

### Production of Test Metal Foil Having Compressed Pattern Portion

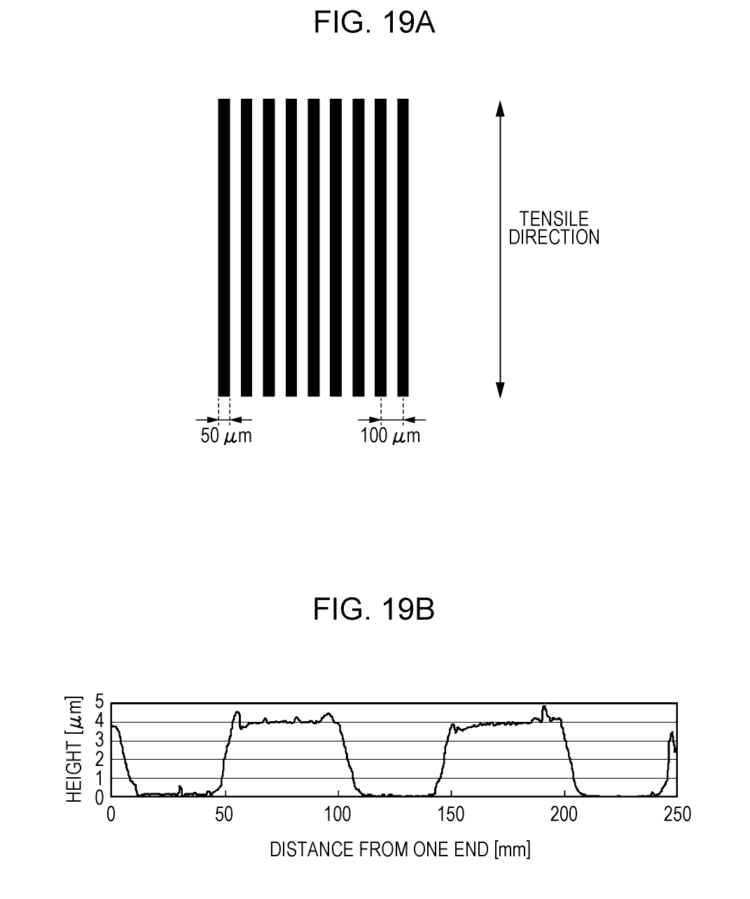

As for the metal foil, mild aluminum foil (A8021H-O) having a thickness of 20 μm was used. This mild aluminum foil was subjected to a press treatment by using the emboss roll produced as described above at a press linear pressure of 100 kgf/cm. In this manner, the compressed pattern portion in a parallel straight-line shape having a width of 50 μm at a pitch of 100 μm, as shown in FIG. 19A, was formed on the mild aluminum foil. In FIG. 19A, the shape indicated by black is a portion which has become the compressed pattern portion having a thickness smaller than the thickness of the other portion through pressing with the emboss roll. At this time, the cross-sectional shape of the mild aluminum foil was measured with a laser microscope (OLS3000, produced by Olympus Corporation). As a result, as shown in FIG. 19B, the height of the unevenness of a compressed portion and an uncompressed portion (or a weakly compressed portion), that is, the depth of the compressed pattern portion, was about 4.0 μm.

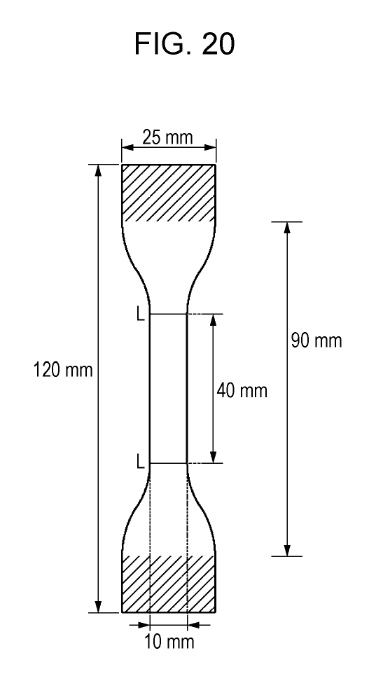

Finally, the mild aluminum foil provided with the straight-line shaped compressed pattern portion was stamped into the shape of a dumbbell, as shown in FIG. 20, so as to produce a test metal foil. This shape of dumbbell was dumbbell No. 1 on the basis of JIS K6251, and a gauge length (distance L-L between bench marks L) serving as a reference was 40 mm. In this regard, stamping was performed in such a way that the direction of continuity of the compressed pattern portion became parallel to the longitudinal direction of the shape of a dumbbell. That is, in the tensile test, the direction of continuity of the compressed pattern portion was the same direction as the tensile direction because the test was performed while both ends of the sample formed into the shape of a dumbbell were fixed. The mild aluminum foil was stamped into the shape of dumbbell No. 1 on the basis of JIS K6251.

### Example 1-2

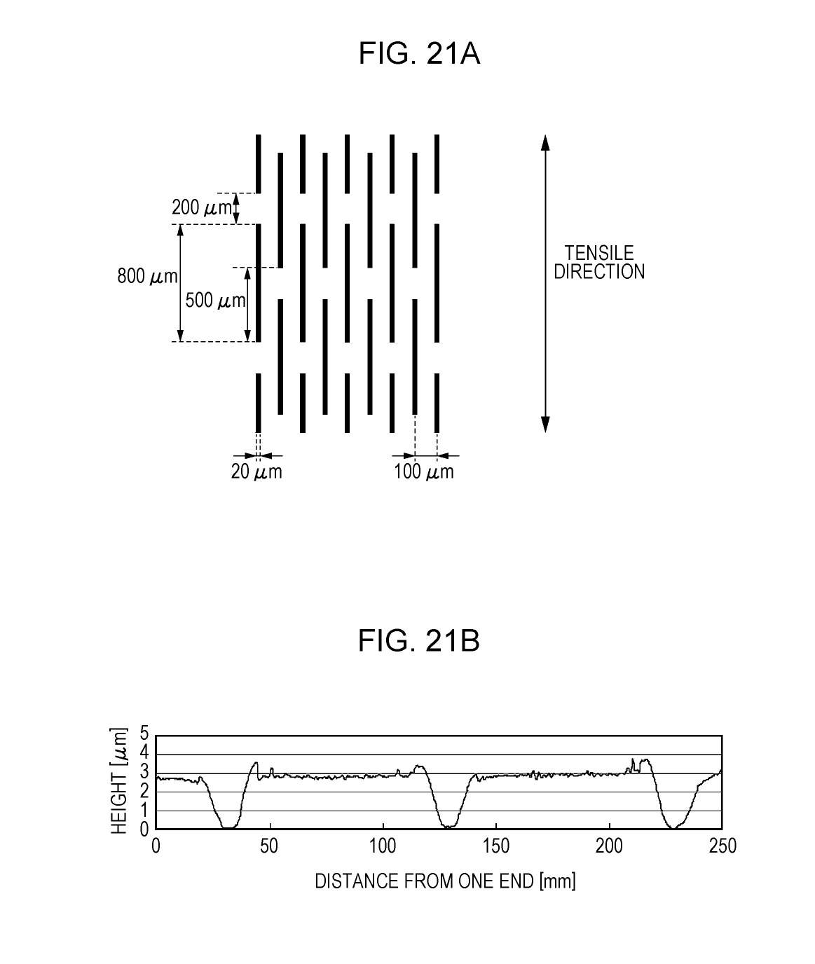

The test metal foil having the compressed pattern portion was produced as in Example 1-1 except that an intermittent straight-line shaped compressed pattern portion was formed by using an emboss roll provided with an intermittent straight-line shaped uneven pattern. As shown in FIG. 21A, the intermittent straight-line shaped compressed pattern portion was parallel intermittent straight lines having a width of 20 μm at a pitch of 100 μm, and each intermittent straight line was specified to have a length of 800 μm and an interval of 200 μm. At this time, the cross-sectional shape of the test metal foil was measured with the same laser microscope as that in Example 1-1. As a result, as shown in FIG. 21B, the height of the unevenness of a compressed portion and an uncompressed portion (or a weakly compressed portion), that is, the depth of the compressed pattern portion, was about 3.0 μm.

### Comparative Example 1-1

The test metal foil in Comparative example 1-1 was produced as in Example 1-1 except that a compressed pattern portion was not formed.

### Comparative Example 1-2

The test metal foil in Comparative example 1-2 was produced as in Example 1-1 except that rolled aluminum foil (A1N30H-H18) having a thickness of 20 μm was used as metal foil and a compressed pattern portion was not formed.

### Comparative Example 1-3

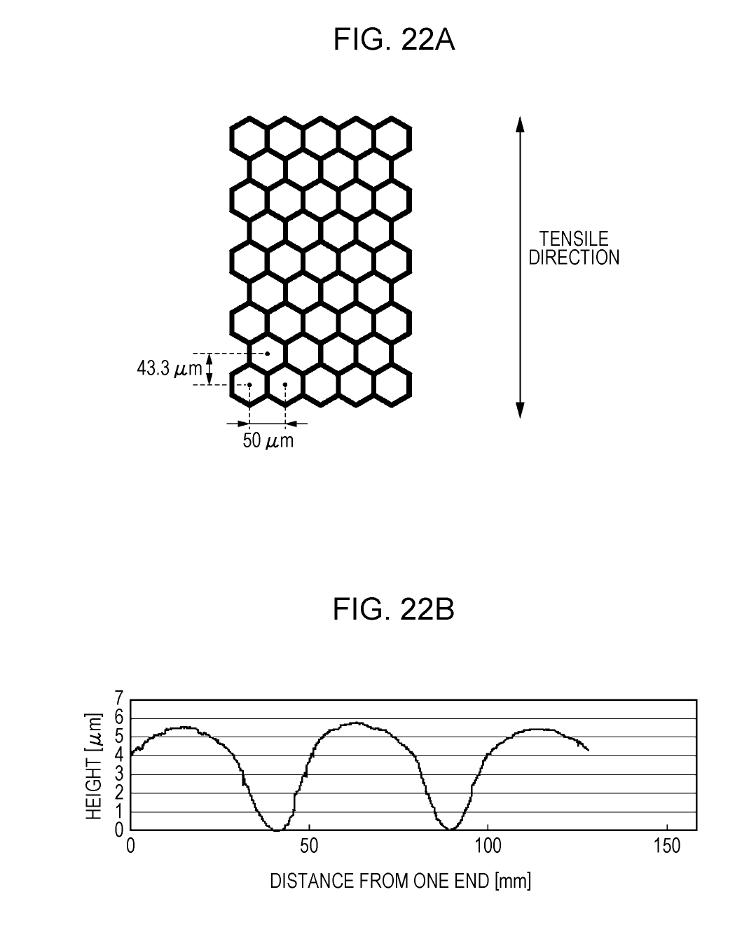

An emboss roll provided with a honeycomb-shaped uneven pattern was used. As shown in FIG. 22A, a honeycomb-shaped compressed pattern portion having a center-to-center distance of regular hexagonal shapes of 50 μm was formed on mild aluminum foil, and the test metal foil in Comparative example 1-3 was produced through stamping into the shape of a dumbbell. The honeycomb-shaped uneven pattern on the emboss roll surface was formed by performing laser beam machining after a thermally sprayed ceramic film was formed on the stainless steel roll surface.

Regarding the test metal foil in Comparative example 1-3, a honeycomb-shaped compressed pattern portion was disposed all over the mild aluminum foil, and the compressed pattern portion was disposed continuously between the two end portions parallel to the tensile direction of the test metal foil. At this time, the cross-sectional shape of the test metal foil was measured with the same laser microscope as that in Example 1-1. As a result, as shown in FIG. 22B, the height of the unevenness of a compressed portion and an uncompressed portion (or a weakly compressed portion), that is, the depth of the compressed pattern portion, was about 5.8 μm.

### Evaluation of Test Metal Foil

### (a) Tensile Test

Regarding the test metal foil of each of the above-described examples and comparative examples, a tensile test was performed with a tensile tester (Autograph AX-5, produced by SHIMADZU CORPORATION) at a tensile speed of 5 mm/min. In example 1, both ends of the dumbbell-shaped test metal foil (regions indicated by diagonally shaded portions shown in FIG. 20) were fixed by the tensile tester. At this time, the distance between the fixed portions at two ends of the test metal foil was specified to be 90 mm. In the tensile test, the 0.2% yield strength and the breaking strain of the test metal foil in each of the examples and the comparative examples were evaluated. The breaking strain was calculated while the gauge length of 40 mm was taken as a reference.

The evaluation results are shown in Table 1 described below.

TABLE 1

| | | | | | Compressed pattern portion | | | | | |
|---|---|---|---|---|---|---|---|---|---|---|
| | | | | | | | | Region provided | Tensile test | |
| | Metal foil material | | | | | | Unevenness | with | 0.2% Yield | Breaking |
| | Metal | | Thickness | | | | height | no compressed | strength | strain |
| | material | Alloy No. | [μm] | Shape | Press shape | Drawing | [μm] | pattern portion | [N/mm²] | [%] |
| Example 1-1 | mild | A8021H-O | 20 | dumbbell | straight line | FIG. 19 | 4.0 | none | 109.0 | 3.2 |
| | aluminum | | | No. 1 | | | | | | |
| Example 1-2 | mild | A8021H-O | 20 | dumbbell | intermittent | FIG. 21 | 3.0 | none | 80.3 | 4.8 |
| | aluminum | | | No. 1 | straight line | | | | | |
| Comparative | mild | A8021H-O | 20 | dumbbell | — | — | — | none | 51.5 | 5.4 |
| example 1-1 | aluminum | | | No. 1 | | | | | | |
| Comparative | rolled | A1N30H- | 20 | dumbbell | — | — | — | none | 149.0 | 2.6 |
| example 1-2 | aluminum | H18 | | No. 1 | | | | | | |
| Comparative | mild | A8021H-O | 20 | dumbbell | honeycomb | FIG. 22 | 5.8 | none | 103.4 | 1.7 |
| example 1-3 | aluminum | | | No. 1 | | | | | | |

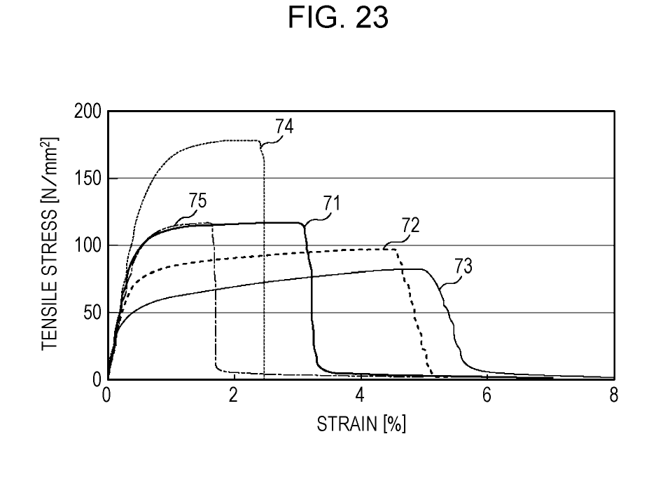

FIG. 23 shows a strain-stress curve in each of the examples and the comparative examples. In FIG. 23, Example 1-1 is indicated by a solid line marked with reference numeral 71, and Example 1-2 is indicated by a dotted line marked with reference numeral 72. Comparative example 1-1 is indicated by a thin line marked with reference numeral 73, Comparative example 1-2 is indicated by a thin dotted line marked with reference numeral 74, and Comparative example 1-3 is indicated by thin alternate long and short dashed lines marked with reference numeral 75.

In Example 1-1, Example 1-2, and Comparative example 1-1, the same material was used for the metal foil. When comparisons are made between them, as is clear from Table 1, regarding Example 1-1 and Example 1-2, in which the compressed pattern portions were disposed, the breaking strain was small as compared with that in Comparative example 1-1 in which the compressed pattern portion was not disposed and, therefore, breakage occurred somewhat easily as compared with the case where the compressed pattern portion was not disposed. However, the 0.2% yield strength was improved remarkably.

When comparisons are made between Comparative example 1-3, in which the honeycomb-shaped compressed pattern portion was disposed, and Example 1-1, Example 1-2, and Comparative example 1-1, it was made clear that regarding Comparative example 1-3, the effect of improving the 0.2% yield strength was exerted to the same extent as that in the examples, but the breaking strain was small and the test metal foil was broken significantly easily. This is because the honeycomb-shaped compressed pattern portion was disposed all over the surface of the test metal foil and, thereby, the compressed pattern portion was formed continuously in the direction perpendicular to the tensile direction, so that breakage of the foil occurred from the compressed pattern portion at the metal foil end portion on the basis of tension.

Regarding Example 1-1 and Example 1-2, it is believed that the compressed pattern portion in Example 1-1 had a larger compressed area and, therefore, the 0.2% yield strength was high and the breaking strain was low.

As described above, the metal foil may have an improved yield strength and be not easily broken by disposing a compressed pattern portion and, in addition, not disposing a continuous compressed pattern portion in the direction perpendicular to the tensile direction.

### Example 2

In Example 2, regarding test metal foil, in which regions provided with no compressed pattern were formed in the vicinity of both end portions parallel to the tensile direction, among the metal foil, the characteristics were examined by the tensile test.

### Example 2-1

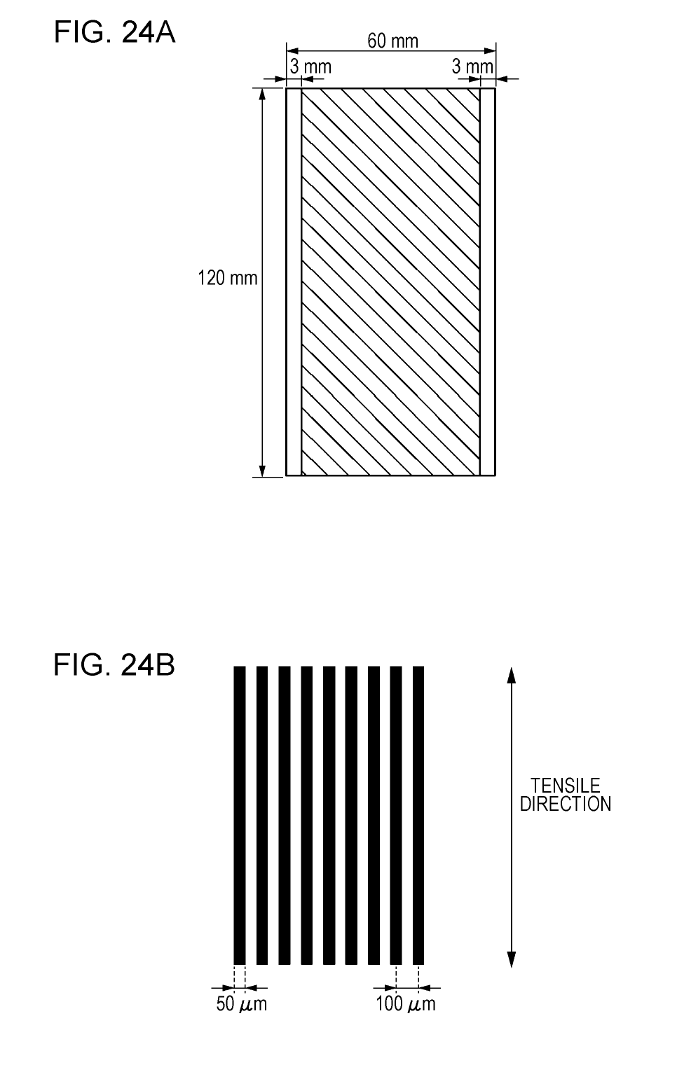

As shown in FIG. 24A, mild aluminum foil (A8021H-O) having a thickness of 20 μm and a width of 60 mm was used as the metal foil. A compressed pattern portion was formed in a region (diagonally shaded portion shown in FIG. 24A) having a width of 54 mm at the central portion excluding regions having a width of 3 mm at both ends in the width direction (total width of 6 mm, 10% of the metal foil width). As shown in FIG. 24B, the compressed pattern portion was specified to be in a straight-line shape extending in the direction perpendicular to the width direction, as in Example 1-1.

The metal foil provided with the compressed pattern portion was cut into the length of 120 mm, so that a test metal foil having a rectangular shape 60 mm wide×120 mm long in Example 2-1 was produced. The straight-line shaped compressed pattern portion was formed by using an emboss roll produced as in Example 1-1 except that the width of the region provided with an uneven pattern was specified to be 54 mm and pressing was performed avoiding both ends, each 3 mm, of the metal foil.

### Example 2-2

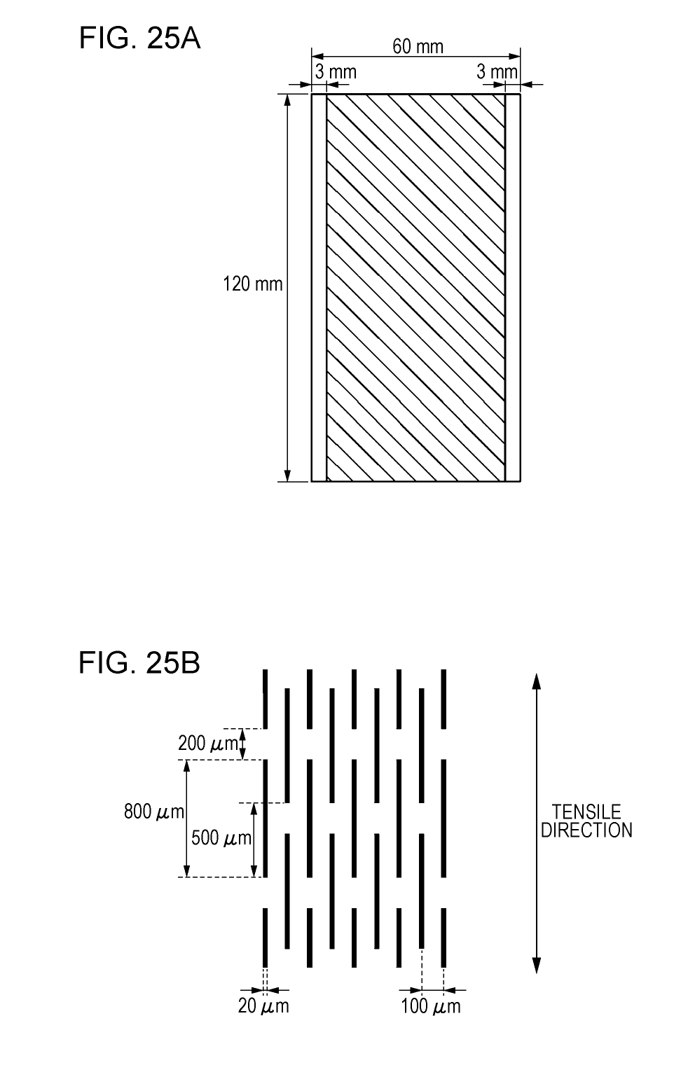

As shown in FIG. 25A and FIG. 25B, the test metal foil in Example 2-2 was produced as in Example 2-1 except that the shape of the compressed pattern portion formed in the region having a width of 54 mm at the central portion excluding the regions having a width of 3 mm at both ends (total width of 6 mm, 10% of the metal foil width) was specified to be an intermittent straight-line shape as in Example 1-2.

### Comparative Example 2-1

The test metal foil in Comparative example 2-1 was produced as in Example 2-1 except that a compressed pattern portion was not formed.

### Comparative Example 2-2

The test metal foil in Comparative example 2-2 was produced as in Example 2-1 except that rolled aluminum foil (A1N30H-H18) having a thickness of 20 μm was used as metal foil and a compressed pattern portion was not formed. Evaluation of test metal foil

### (a) Tensile Test

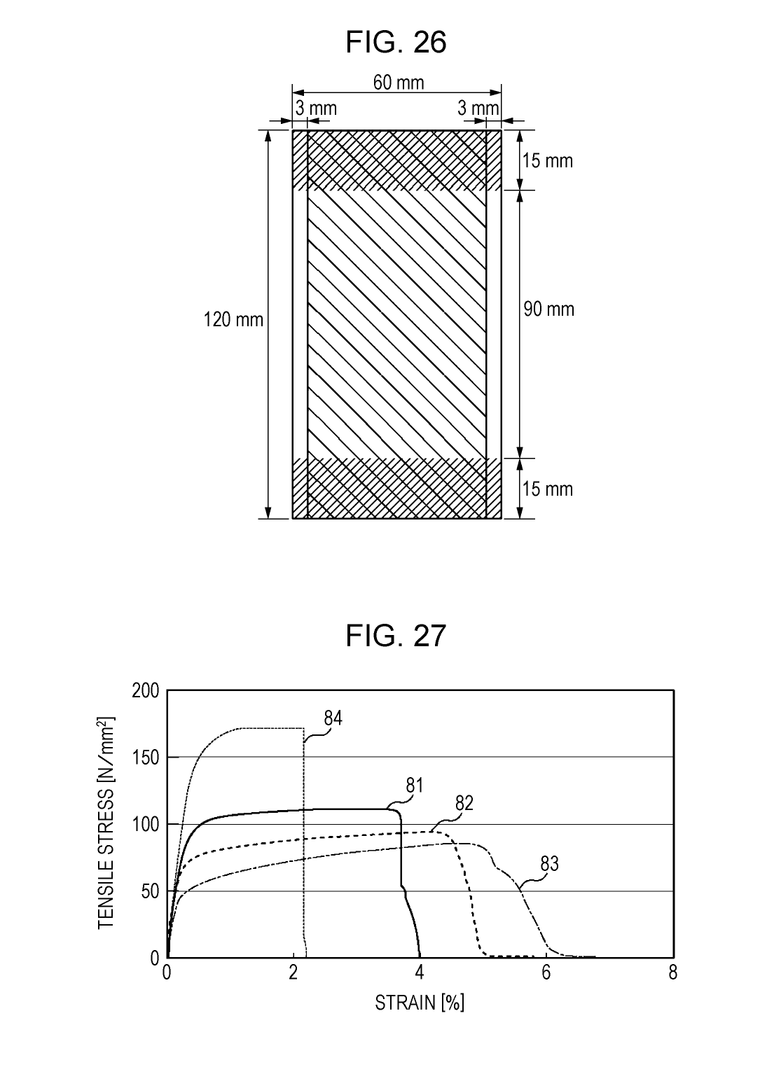

Regarding the test metal foil of each of the above-described examples and comparative examples, the tensile test was performed in the same manner as that in Example 1. In example 2, both ends of the rectangular test metal foil were fixed by the tensile tester. At this time, both ends, each 15 mm, of the test metal foil were fixed, and the distance between the fixed portions was specified to be 90 mm, as shown in FIG. 26. In the tensile test, the 0.2% yield strength and the breaking strain of the test metal foil in each of the examples and the comparative examples were evaluated. The breaking strain was calculated while the distance between the fixed portions of 90 mm was taken as a reference.

The evaluation results are shown in Table 2 described below.

TABLE 2

| | | | | | | Compressed pattern portion | | | | | |
|---|---|---|---|---|---|---|---|---|---|---|---|
| | | | | | | | | Total | | | |
| | | | | | | | | width of | | | |
| | | | | | | | | region | Proportion | | |
| | | | | | | | Region | with | of width | | |
| | | | | | | | provided | no com- | of region | Tensile test | |
| | Metal foil | | | | | | with no | pressed | with no | 0.2% | |
| | | | Thick- | | | | compressed | pattern | compressed | Yield | Breaking |
| | Metal | | ness | | Width | | pattern | portion | pattern | strength | strain |
| | material | Alloy No. | [μm] | Shape | [mm] | Press shape | portion | [mm] | portion [%] | [N/mm²] | [%] |
| Example 2-1 | mild | A8021H-O | 20 | rectangular | 60 | straight line | present (both | 6 | 10 | 96.1 | 4.0 |
| | aluminum | | | | | | ends) | | | | |
| Example 2-2 | mild | A8021H-O | 20 | rectangular | 60 | intermittent | present (both | 6 | 10 | 71.6 | 5.2 |
| | aluminum | | | | | straight line | ends) | | | | |
| Comparative | mild | A8021H-O | 20 | rectangular | 60 | — | None | 0 | 0 | 50.0 | 5.6 |
| example 2-1 | aluminum | | | | | | | | | | |
| Comparative | rolled | A1N30H- | 20 | rectangular | 60 | — | None | 0 | 0 | 148.2 | 2.4 |
| example 2-2 | aluminum | H18 | | | | | | | | | |

FIG. 27 shows a strain-stress curve in each of the examples and the comparative examples. In FIG. 27, Example 2-1 is indicated by a solid line marked with reference numeral 81, and Example 2-2 is indicated by a dotted line marked with reference numeral 82. Comparative example 2-1 is indicated by thin alternate long and short dashed lines marked with reference numeral 83, and Comparative example 2-2 is indicated by a thin dotted line marked with reference numeral 84.

As is clear from Table 2, when Example 2-1, Example 2-2, and Comparative example 2-1, in which the same material was used for the metal foil, are compared, regarding Example 2-1 and Example 2-2, in which the compressed pattern portion was disposed, the breaking strain was small, but the 0.2% yield strength was improved remarkably as compared with that in Comparative example 2-1 in which the compressed pattern portion was not disposed.

When each example is compared with Comparative example 2-2, in which a compressed pattern portion was not disposed and the rolled aluminum foil was used, the 0.2% yield strength was low, but the breaking strain was large, so that breakage did not occur easily.

Regarding Example 2-1, the 0.2% yield strength was somewhat low, but the breaking strain was improved as compared with those in Example 1-1. This is because the regions provided with no compressed pattern were disposed at both end portions parallel to the tensile direction and, thereby, the area of the compressed pattern portion was somewhat reduced.

### Example 3

In Example 3, regarding the test metal foil, in which the regions provided with no compressed pattern were disposed in the vicinity of both end portions parallel to the tensile direction, among the metal foil, and the width of the compressed pattern portion was changed, the characteristics were examined by the tensile test.

In Example 3, the widths in the individual examples and comparative examples were different because of constraints in production of the test metal foil. Consequently, in order to equalize the condition of the tensile test with that in Example 2, the width of the test metal foil and the distance between the fixed portions were specified in such a way that the ratio thereof was equalized with the ratio of the width of the test metal foil of 60 mm to the distance between the fixed portions of 90 mm in Example 2.

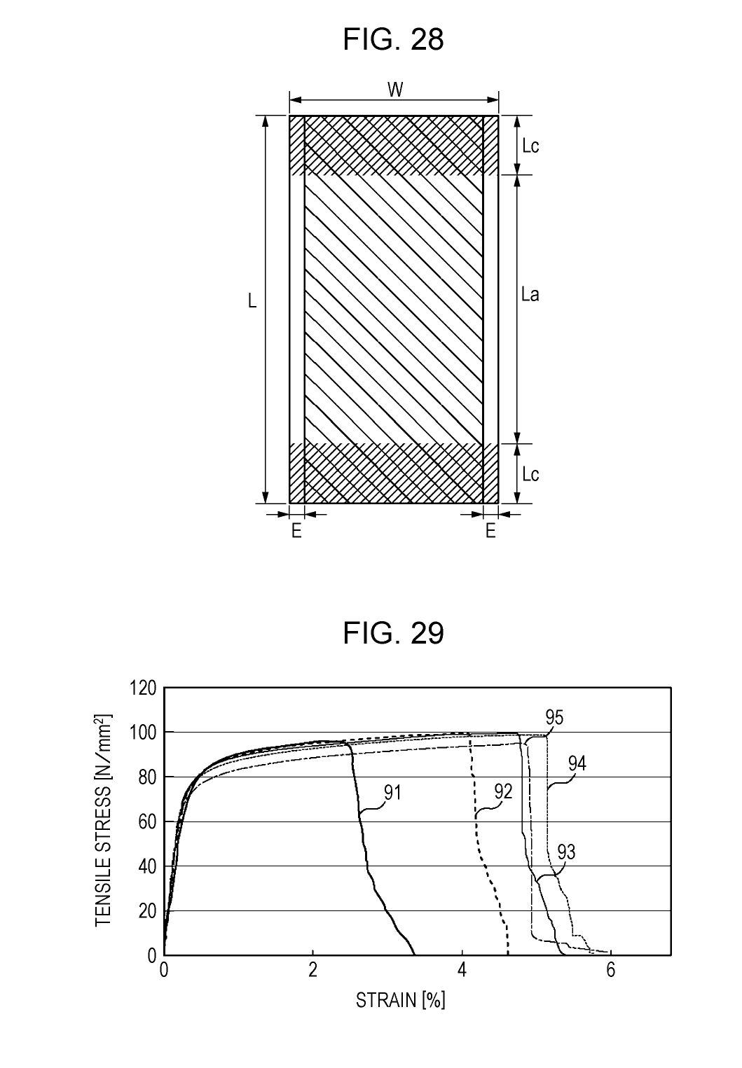

That is, as shown in FIG. 28, regions provided with no compressed pattern having a width of E (total 2E) were formed at both end portions in the longitudinal direction of the metal foil having a length of L and a width of W, and the tensile test was performed. At this time, the fixing length Lc per side in fixing of both end portions of the metal foil in the tensile test was specified to be 20 mm, and the length L was adjusted in such a way that the width W of the metal foil and the distance between the fixed portions La (La=L−40) satisfied W:La=1:1.5.

The individual examples and comparative examples will be concretely described below.

### Example 3-1

Mild aluminum foil (A8021H-O) having a thickness of 20 μm and a width of 30.0 mm was used as the metal foil. The width E of the regions provided with no compressed pattern was specified to be 0 mm (total width 0 mm, 0% of the metal foil width), and the same intermittent straight-line shaped compressed pattern portion as that in Example 2-2 was formed all over the surface of the metal foil.

Subsequently, the metal foil provided with the compressed pattern portion was cut into the length of 85.0 mm, so as to have a rectangular shape 30.0 mm wide×85.0 mm long. The length of the metal foil was adjusted to satisfy 30:(length L−40)=1:1.5. A test metal foil in Example 3-1 was produced as in Example 2-1 except those described above.

### Example 3-2

The test metal foil in Example 3-2 was produced as in Example 2-1 except that mild aluminum foil (A8021H-O) having a thickness of 20 μm and a width of 36.3 mm was used as the metal foil, and the compressed pattern portion was formed in the region having a width of 34.5 mm at the central portion excluding the regions having a width of 0.9 mm at both ends in the width direction of the metal foil (total width of 1.8 mm, 5% of the metal foil width).

### Example 3-3

The test metal foil in Example 3-3 was produced as in Example 2-1 except that mild aluminum foil (A8021H-O) having a thickness of 20 μm and a width of 38.3 mm was used as the metal foil, and the compressed pattern portion was formed in the region having a width of 34.5 mm at the central portion excluding the regions having a width of 1.9 mm at both ends in the width direction of the metal foil (total width of 3.8 mm, 10% of the metal foil width).

### Example 3-4

The test metal foil in Example 3-4 was produced as in Example 2-1 except that mild aluminum foil (A8021H-O) having a thickness of 20 μm and a width of 43.1 mm was used as the metal foil, and the compressed pattern portion was formed in the region having a width of 34.5 mm at the central portion excluding the regions having a width of 4.3 mm at both ends in the width direction of the metal foil (total width of 8.6 mm, 20% of the metal foil width).

### Example 3-5

The test metal foil in Example 3-5 was produced as in Example 2-1 except that mild aluminum foil (A8021H-O) having a thickness of 20 μm and a width of 57.5 mm was used as the metal foil, and the compressed pattern portion was formed in the region having a width of 34.5 mm at the central portion excluding the regions having a width of 11.5 mm at both ends in the width direction of the metal foil (total width of 23 mm, 40% of the metal foil width).

### Evaluation of Test Metal Foil

### (a) Tensile Test

Regarding the test metal foil of each of the above-described examples, as shown in FIG. 28, the tensile test was performed in the same manner as that in Example 2. In the tensile test, the 0.2% yield strength and the breaking strain of the test metal foil in each of the examples were evaluated. The breaking strain was calculated while the distance between the fixed portions of La was taken as a reference.

The evaluation results are shown in Table 3 described below

TABLE 3

| | | | | | | | Compressed pattern portion | | | |
|---|---|---|---|---|---|---|---|---|---|---|
| | | | | | | | | Width | | Proportion of |
| | | | | | | | | of region | Total width of | width of region |
| | Metal foil | | | | | | | provided with | region with no | with no |
| | | | | | Width | | | no compressed | compressed | compressed |
| | Metal | | Thickness | | W | Length L | | pattern portion | pattern portion | pattern portion |
| | material | Alloy No. | [μm] | Shape | [mm] | [mm] | Press shape | E [mm] | [mm] | [%] |
| Example | mild | A8021H-O | 20 | rectangular | 30.0 | 85.0 | intermittent | 0 | 0 | 0 |
| 3-1 | aluminum | | | | | | straight line | | | |
| Example | | | | | 36.0 | 94.5 | | 0.9 | 1.8 | 5 |
| 3-2 | | | | | | | | | | |
| Example | | | | | 38.3 | 97.5 | | 1.9 | 3.8 | 10 |
| 3-3 | | | | | | | | | | |
| Example | | | | | 43.1 | 104.7 | | 4.3 | 8.6 | 20 |
| 3-4 | | | | | | | | | | |
| Example | | | | | 57.5 | 126.3 | | 11.5 | 23.0 | 40 |
| 3-5 | | | | | | | | | | |

| | | | Tensile test | |
|---|---|---|---|---|
| | | Distance between | 0.2% Yield strength | Breaking strain |
| | Fixing length Lc [mm] | fixed portions La [mm] | [N/mm²] | [%] |
| Example | 20.0 | 45.0 | 81.9 | 2.6 |
| 3-1 | | | | |
| Example | | 54.5 | 79.9 | 4.2 |
| 3-2 | | | | |
| Example | | 57.5 | 79.2 | 4.8 |
| 3-3 | | | | |
| Example | | 64.7 | 77.9 | 5.2 |
| 3-4 | | | | |
| Example | | 86.3 | 73.4 | 4.9 |
| 3-5 | | | | |

FIG. 29 shows a strain-stress curve in each of the examples. In FIG. 29, Example 3-1 is indicated by a solid line marked with reference numeral 91, and Example 3-2 is indicated by a dotted line marked with reference numeral 92. Example 3-3 is indicated by a thin line marked with reference numeral 93, Example 3-4 is indicated by a thin dotted line marked with reference numeral 94, and Example 3-5 is indicated by thin alternate long and short dashed lines marked with reference numeral 95.

As is clear from Example 3-1 and Examples 3-2 to 3-5 shown in Table 3, the breaking strain was improved remarkably by specifying the proportion of the region provided with no compressed pattern relative to the metal foil width to be 5% or more. Meanwhile, the 0.2% yield strength was linearly reduced as the proportion of the region provided with no compressed pattern increases. The breaking strain in Example 3-2, in which the proportion of the region provided with no compressed pattern was 5%, was improved as compared with that in Example 3-1, in which a region provided with no compressed pattern was not disposed, because of difference in the state of the edge of the metal foil. That is, in cutting of the metal foil, fine cracking occurs easily at the edge portion of the metal foil. Regarding Example 3-1, breakage occurred where this fine cracking served as the starting point, whereas regarding Example 3-2, breakage was suppressed because the regions provided with no compressed pattern were disposed.

As described above, in the case where the region provided with no compressed pattern is not disposed at the end portion, an influence of the state of the edge of the metal foil may be exerted. However, such an influence of the state of the edge may be minimized by disposing the regions provided with no compressed pattern at end portions of the metal foil.

According to each of the above-described examples, the proportion of the region provided with no compressed pattern relative to the metal foil width is preferably 5% or more and 40% or less, and more preferably 10% or more and 20% or less. This is because the breaking strain may be further improved by specifying the proportion of the region provided with no compressed pattern relative to the metal foil width to be 10% or more, and a reduction in 0.2% yield strength may be suppressed by specifying the proportion to be 20% or less.

Regarding both Example 1-2 and Example 3-1, the region provided with no compressed pattern was not disposed. However, the shapes of the whole test metal foil and the dimensions (gauge length, distance between the fixed portions) of the portion serving as a reference of the tensile test were different between Example 1-2 and Example 3-1 and, therefore, the numerical values of the evaluation results were different. Concretely, the shapes of the test metal foil were different, so that there was a difference in the edge shape (smoothly curved shape and straight-line shape) between the test metal foil. Furthermore, the gauge lengths were different, but the tensile speeds were equivalent, so that there was a difference in strain rate. Consequently, there was a difference in the evaluation result.

Likewise, the total widths of the regions provided with no compressed pattern in both Example 2-2 and Example 3-3 were 10% of the metal foil width, but the dimensions (gauge length, distance between the fixed portions) of the portion serving as a reference of the tensile test were different between Example 2-2 and Example 3-3 and, therefore, the numerical values of the evaluation results were different. In this case as well, the gauge lengths were different, but the tensile speeds were equivalent, so that there was a difference in strain rate. Consequently, there was a difference in the evaluation result.

Up to this point, the present disclosure has been explained with reference to the individual embodiments and examples. However, the present disclosure is not limited to them, and various modifications may be made within the scope of the gist of the present disclosure. For example, the shape of the compressed pattern portion may be the shapes other than those shown in the drawings.

The nonaqueous electrolyte batteries explained in the second embodiment and the third embodiment are no more than examples. The collectors according to embodiments of the present disclosure may be used for various batteries, e.g., a battery in which the rolled electrode assembly was formed into a flat type, a rectangular battery, and a coin type battery.

The collectors according to embodiments of the present disclosure may be used for both the primary batteries and the secondary batteries, but may be used for the secondary batteries, in which strain occurs easily in the structure of the electrode assembly because charge and discharge are repeated a plurality of times, more favorably.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
a rolled electrode assembly, in which a positive electrode and a negative electrode are stacked with a separator therebetween and are rolled,
the positive electrode including a positive electrode active material layer containing a positive electrode active material and being disposed on the surface of a positive electrode collector formed from metal foil,
the negative electrode including a negative electrode active material layer containing a negative electrode active material and being disposed on the surface of a negative electrode collector formed from metal foil, and
the separator insulating the positive electrode from the negative electrode; and
an electrolyte,
wherein at least one of the positive electrode collector and the negative electrode collector has a compressed pattern portion,
which is disposed as a part of the metal foil and
which has a thickness smaller than the thickness of the other portion through compression, and
the compressed pattern portion from one end parallel to the rolling direction of the metal foil to the other end opposite to the one end is not disposed continuously in the direction orthogonal to the rolling direction of the metal foil.

2. The nonaqueous electrolyte battery according to claim 1,
wherein the compressed pattern portion has
a linear shape disposed continuously or intermittently in the rolling direction of the positive electrode collector and the negative electrode collector or
a geometric shape disposed all over the surfaces of the positive electrode collector and the negative electrode collector dispersedly.

3. The nonaqueous electrolyte battery according to claim 2,
wherein the compressed pattern portion has
a straight line or curved line shape disposed continuously or intermittently in the rolling direction of the positive electrode collector and the negative electrode collector or
a flat geometric shape disposed all over the surfaces of the positive electrode collector and the negative electrode collector dispersedly while extending in the rolling direction.

4. The nonaqueous electrolyte battery according to claim 1, comprising
a cross-sectional shape in which the compressed pattern portion and the other region not provided with the compressed pattern portion of the metal foil are ranged having a curvature.

5. The nonaqueous electrolyte battery according to claim 1,
wherein both end portions parallel to the rolling direction of the metal foil are portions provided with no compressed pattern in which the compressed pattern portion is not disposed.

6. A nonaqueous electrolyte battery comprising:
an electrode assembly, in which a positive electrode and a negative electrode are stacked with a separator therebetween,
the positive electrode including a positive electrode active material layer containing a positive electrode active material and being disposed on the surface of a positive electrode collector formed from metal foil,
the negative electrode including a negative electrode active material layer containing a negative electrode active material and being disposed on the surface of a negative electrode collector formed from metal foil, and
the separator insulating the positive electrode from the negative electrode; and
an electrolyte,
wherein at least one of the positive electrode collector and the negative electrode collector has a compressed pattern portion
which is disposed as a part of the metal foil and
which has a thickness smaller than the thickness of the other portion through compression, and
the compressed pattern portion is not disposed continuously in the directions of two groups of opposite sides of the metal foil.

7. The nonaqueous electrolyte battery according to claim 6,
wherein the compressed pattern portion has a geometric shape disposed all over the surfaces of the positive electrode collector and the negative electrode collector dispersedly.

8. The nonaqueous electrolyte battery according to claim 6,
wherein an end portion is a portion provided with no compressed pattern in which the compressed pattern portion is not disposed.

9. A rolled electrode assembly collector comprising
a compressed pattern portion,
which is disposed as a part of a band-shaped metal foil and
which has a thickness smaller than the thickness of the other portion through compression,
wherein the compressed pattern portion is not disposed continuously in the short-side direction of the metal foil.

10. The rolled electrode assembly collector according to claim 9,
wherein the compressed pattern portion has
a linear shape disposed continuously or intermittently in the longitudinal direction of the metal foil or
a geometric shape disposed all over the surface of the metal foil dispersedly.

11. A layer-built electrode assembly collector comprising
a compressed pattern portion, which is disposed as a part of a rectangular metal foil and which has a thickness smaller than the thickness of the other portion through compression,
wherein the compressed pattern portion is not disposed continuously in the directions of two groups of opposite sides of the metal foil.

12. The layer-built electrode assembly collector according to claim 11,
wherein the compressed pattern portion has a geometric shape disposed all over the surface of the metal foil dispersedly.

13. A method for manufacturing a nonaqueous electrolyte battery collector comprising:
subjecting metal foil to a press treatment by a metal roll provided with an uneven pattern having a shape not continued from one end of the metal foil to the other end opposite to the one end,
so as to form a compressed pattern portion corresponding to the uneven pattern of the metal roll and having a thickness smaller than the thickness of the other portion, as a part of the metal foil.

14. The method for manufacturing a nonaqueous electrolyte battery collector according to claim 13,
wherein the compressed pattern portion is formed on the metal foil while having
a linear shape disposed continuously or intermittently from the one end of the metal foil in the direction orthogonal to the other end opposite to the one end or
a geometric shape disposed all over the surface of the metal foil dispersedly.

15. A battery pack comprising:
the nonaqueous electrolyte battery according to claim 1;
a control portion to control the nonaqueous electrolyte battery; and
an outer case including the nonaqueous electrolyte battery.

16. An electronic apparatus comprising:
aqueous electrolyte battery according to claim 1,
wherein an electric power is supplied from the nonaqueous electrolyte battery.

17. An electric vehicle comprising:
the nonaqueous electrolyte battery according to claim 1;
a convertor to convert an electric power supplied from the nonaqueous electrolyte battery to a driving force of a vehicle; and
a controller to perform information processing with respect to vehicle control on the basis of the information regarding the nonaqueous electrolyte battery.

18. An electricity storage device comprising
the nonaqueous electrolyte battery according to claim 1,
wherein an electric power is supplied to an electronic apparatus connected to the nonaqueous electrolyte battery.

19. The electricity storage device according to claim 18 comprising
an electric power information controller to transmit and receive signals to and from other apparatuses through a network,
wherein charge and discharge of the nonaqueous electrolyte battery is controlled on the basis of the information received by the electric power information controller.

20. An electric power system,
wherein an electric power is supplied from the nonaqueous electrolyte battery according to claim 1 or
an electric power is supplied from a generating set or an electric power network to the nonaqueous electrolyte battery.
